(19) United States
(12) Patent Application Publication
(10) Pub. No.: US 2025/0117696 A1
(43) Pub. Date: Apr. 10, 2025

(54) ELECTRONIC DEVICE AND METHOD OF ELECTRONIC DEVICE GENERATING PREDICTIVE MODEL BASED ON CLASSIFICATION OF PATTERNS OF TIME-SERIES DATA TO WHICH PRE-PROCESSING PIPELINE HAS BEEN APPLIED

(71) Applicant: Korea Electronics Technology Institute, Seongnam-si (KR)

(72) Inventors: JaeWon Moon, Seoul (KR); Seung Woo Kum, Yongin-si (KR); Seungtaek Oh, Seoul (KR)

(21) Appl. No.: 18/524,989

(22) Filed: Nov. 30, 2023

(30) Foreign Application Priority Data
Oct. 10, 2023 (KR) 10-2023-0134558

(51) Int. Cl. G06N 20/00

(52) U.S. Cl. CPC G06N 20/00

(57) ABSTRACT

A method of generating a predictive model is proposed. The method may include receiving single time-series data or multiple types of time-series data collected in a specific domain, drawing time-series data corresponding to the same domain and time interval, among the received single time-series data or multiple types of time-series data. The method may also include pre-processing the drawn time-series data by applying a pre-processing pipeline built by applying at least one pre-processing module to the drawn time-series data, and generating a pattern classification model for classifying patterns of the pre-processed time-series data based on the clustering of the pre-processed time-series data. The method may further include generating a predictive model for predicting feature information of the drawn time-series data based on a cluster that is generated as the results of the clustering of the pre-processed time-series data, and storing the pattern classification model and the predictive model.

### CROSS-REFERENCE TO RELATED APPLICATION

This application claims priority to and the benefit of Korean Patent Application No. 10-2023-0134558, filed on Oct. 10, 2023, the disclosure of which is incorporated herein by reference in its entirety.

### BACKGROUND

### Technical Field

The present disclosure relates to an electronic device and a method of the electronic device generating a predictive model based on the classification of patterns of time-series data to which a pre-processing pipeline has been applied.

### Description of Related Technology

Recently, with the spread of a machine learning technology and an IoT device, attempts to collect time-series data by using a sensor and to extract meaningful information in various fields, such as a smart farm and a smart factory, continue. Time-series data that have been accumulated in real time as described above need to be processed and used through a big data processing method because the size of the time-series data is very large.

### SUMMARY

Various embodiments are directed to providing an electronic device, which builds a pipeline capable of pre-processing single or multiple types of time-series data, pre-processes the single or multiple types of time-series data, and enables the prediction of feature information for corresponding time-series data by using the existing trained predictive model if available data, among the pre-processed time-series data, are not sufficient, upon inference based on new time-series data, and a method of the electronic device generating a predictive model based on the classification of patterns of time-series data to which a pre-processing pipeline has been applied.

A method of generating a predictive model based on the classification of patterns of time-series data to which a pre-processing pipeline has been applied, which is performed by an electronic device, according to a first aspect of the present disclosure, includes receiving single time-series data or multiple types of time-series data that are collected in a specific domain, drawing time-series data corresponding to an identical domain and an identical time interval, among the received single time-series data or multiple types of time-series data, pre-processing the drawn time-series data by applying a pre-processing pipeline built by applying at least one pre-processing module to the drawn time-series data, generating a pattern classification model for classifying patterns of the pre-processed time-series data based on the clustering of the pre-processed time-series data, generating a predictive model for predicting feature information of the drawn time-series data based on a cluster that is generated as the results of the clustering of the pre-processed time-series data, and storing the pattern classification model and the predictive model.

Furthermore, an electronic device according to a second aspect of the present disclosure includes a processor configured to receive single or multiple types of time-series data that are collected in a specific domain, build a pre-processing pipeline by applying at least one pre-processing module to the time-series data, and pre-process the time-series data by applying the built pre-processing pipeline.

Furthermore, an electronic device according to a third aspect of the present disclosure includes a processor configured to draw time-series data corresponding to an identical domain and an identical time interval, among time-series data that have been previously collected in a specific domain, generate a pattern classification model for classifying patterns of the time-series data based on the clustering of the drawn time-series data, store the generated pattern classification model, generate a predictive model for predicting feature information of the drawn time-series data based on a cluster that is generated as the results of the clustering of the time-series data, and store the generated predictive model.

In addition, another method for implementing an embodiment of the present disclosure, another system, and a computer-readable recording medium on which a computer program for executing the method is recorded may be further provided.

According to an embodiment of the present disclosure, a target time interval in which time-series data need to be pre-processed can be segmented so that a proper pre-processing module is disposed in the target time interval. The proper pre-processing module can be constructed as a pre-processing pipeline so that flexible and robust pre-processing is performed on faulty time-series data. In particular, not only single time-series data, but multiple types of time-series data can be pre-processed. After various pre-processing pipelines are previously built, a structure to which an optimal pre-processing pipeline may be applied may be operated.

Furthermore, even in the state in which it is difficult to apply an artificial intelligence model because time-series data are not sufficiently collected, a plurality of predictive models that have been trained based on collected time-series data is selected and applied. Accordingly, there is an advantage in that fast analysis and prediction using artificial intelligence are possible.

In particular, a predictive model according to a time interval and a pattern can be generated and applied by considering a feature of time-series data.

Furthermore, there is an advantage in that fast data analysis is possible because a predictive model can be simply selected and used although it is difficult to locally transmit a large amount of data.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1A is a diagram illustrating original data including periodical abnormal-value data.

FIG. 1B is a diagram illustrating the results of the application of a task for sequentially applying down-sampling and abnormal value detection pre-processing processes on the original data in FIG. 1A.

FIG. 1C is a diagram illustrating the results of the application of a task for sequentially applying abnormal value detection and down-sampling pre-processing processes on the original data in FIG. 1A.

FIG. 2 is a block diagram illustrating a construction of an electronic device 200 according to an embodiment of the present disclosure.

FIG. 3 is a flowchart of a method of generating a predictive model based on the classification of patterns of time-series data to which a pre-processing pipeline has been applied according to an embodiment of the present disclosure.

FIG. 4 is a diagram for schematically describing a process of building a pre-processing pipeline according to an embodiment of the present disclosure.

FIG. 5 is a diagram for describing a process of building a pre-processing pipeline in an embodiment of the present disclosure.

FIG. 6A is a diagram for describing an example in which a pre-processing module is applied to multiple types of time-series data in an embodiment of the present disclosure.

FIG. 6B is a diagram for describing another example in which a pre-processing module is applied to multiple types of time-series data in an embodiment of the present disclosure.

FIG. 7 is a diagram for describing a process of building a pre-processing pipeline depending on single time-series data or multiple types of time-series data in an embodiment of the present disclosure.

FIG. 8 is a diagram for describing a process of pre-processing time-series data based on a physical characteristic interval in an embodiment of the present disclosure.

FIGS. 9A and 9B are diagrams illustrating examples of the results of the classification of patterns of time-series data in an embodiment of the present disclosure.

FIG. 10 is a diagram for describing contents in which the results of the prediction of new time-series data are output in an embodiment of the present disclosure.

FIG. 11 is a diagram illustrating the entire flowchart of a method of generating a predictive model according to an embodiment of the present disclosure.

FIGS. 12A and 12B are diagrams illustrating examples in which time-series data have been purified based on a reference description period.

FIG. 13 is a diagram illustrating time-series data including omission data.

FIG. 14 is a diagram for describing a processing process if omission data are included in an embodiment of the present disclosure.

FIG. 15 is a diagram illustrating a form in which the interval of first data is set according to an execution method according to an embodiment of the present disclosure.

FIG. 16 is a diagram illustrating a form in which second data are generated according to an execution method according to an embodiment of the present disclosure.

FIG. 17 is a diagram illustrating a form in which second data are processed based on a data supplementation condition according to an execution method according to an embodiment of the present disclosure.

FIG. 18 is a diagram illustrating a form in which second data are processed according to an execution method according to an embodiment of the present disclosure.

FIG. 19 is a diagram for describing a process of processing abnormal data and omission data according to another embodiment of the present disclosure.

FIG. 20 is a diagram illustrating a form in which the electronic device operates according to an embodiment of the present disclosure.

FIG. 21 is a diagram illustrating a form in which the electronic device operates according to another embodiment of the present disclosure.

### DETAILED DESCRIPTION

Time-series data include multiple error data and lost data because the time-series data have a characteristic dependent on the time. Furthermore, the time-series data may be applied to good analysis results and artificial intelligence only when a lot of time is spent for the purification of the time-series data compared to other data due to the incompleteness of the time-series data. Furthermore, if time-series data are not sufficient, there is a difficulty in generating a predictive model.

Advantages and characteristics of the present disclosure and a method for achieving the advantages and characteristics will become apparent from the embodiments described in detail later in conjunction with the accompanying drawings. However, the present disclosure is not limited to embodiments disclosed hereinafter, but may be implemented in various different forms. The embodiments are merely provided to complete the present disclosure and to fully notify a person having ordinary knowledge in the art to which the present disclosure pertains of the category of the present disclosure. The present disclosure is merely defined by the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements in addition to a mentioned element. Throughout the specification, the same reference numerals denote the same elements. “And/or” includes each of mentioned elements and all combinations of one or more of mentioned elements. Although the terms “first”, “second”, etc. are used to describe various components, these elements are not limited by these terms. These terms are merely used to distinguish between one element and another element. Accordingly, a first element mentioned hereinafter may be a second element within the technical spirit of the present disclosure.

All terms (including technical and scientific terms) used in this specification, unless defined otherwise, will be used as meanings which may be understood in common by a person having ordinary knowledge in the art to which the present disclosure pertains. Furthermore, terms defined in commonly used dictionaries are not construed as being ideal or excessively formal unless specially defined otherwise.

Hereinafter, in order to help understanding of those skilled in the art, a proposed background of the present disclosure is first described and an embodiment of the present disclosure is then described. The background and the embodiment may include contents which may be applied to the present disclosure. In this case, it may be naturally said that the described contents cannot be applied as a conventional technology.

Attempts to obtain insight by applying analysis, prediction, and classification schemes to time-series data are continuously made in various industry groups as a large amount of time-series data are generated, spread, and distributed due to the spread and distribution of IoT devices.

Furthermore, attempts to open important data, such as public data portals, Seoul Open Data Plaza, and card big data platforms, and to enable multiple users to use the important data for various purposes are also continued on the basis of local governments and public institutions.

Furthermore, attempts to collect time-series data through various sensors and to improve productivity by applying machine learning are made in several domains, such as smart farms, smart factories, and smart cities.

The collected time-series data includes faulty data, or may need to be pre-processed for processing and conversion depending on their utilization purposes.

If time-series data are collected without special control for a long period at several places, most of the time-series data include multiple faulty data and lost intervals having various lengths. The reason why such faulty data are generated is various. For example, the reason may include a data transmission error attributable to a network state, a measured value error according to a sensor failure, and a loss of specific interval data attributable to the occurrence of a problem with a storage place.

Accordingly, in order to use data including such a failure, additional pre-processing is essentially required prior to the utilization of the data. In general, a method of confirming an aspect of a problem occurring due to a failure and solving the problem is selectively applied. For example, various methods, such as a method of detecting and deleting corresponding data when time-series data include multiple abnormal values, a method of supplementing data when the data are lost, and a method of uniformalizing data if the data have not been recorded at uniform time intervals, may be applied. However, such several problems may occur simultaneously, and may occur in different forms for a varying time. Therefore, in order to pre-process such time-series data, proper methods need to be applied in proper time intervals. However, research of the pre-processing of time-series data is basically focused on one problem and the solving of the problem (i.e., pre-processing).

Furthermore, time-series data need to be processed again depending on their utilization purposes. The time-series data may be used as various purposes, such as the analysis, learning, and monitoring of data. For the utilization of the various purposes, a proper data form needs to be provided.

Furthermore, there is a case in which data need to be up-sampled or down-sampled along the lapse of time. This is for reducing the size of the data or matching different time description periods of the data for fast processing. To this end, the data need to be converted into proper data by decreasing or increasing the size of the data with respect to a time axis.

Furthermore, there is a case in which data that are described along a time axis are represented into another dimension, such as a frequency domain, for the analysis and learning of the data. Furthermore, if distribution region scales of time-series data values are greatly different from each other, the time-series data may be converted through a proper normalization process because the results of the training or analysis of the model are not good and the processing speed of the model may become slow. Various and several time-series data processing methods need to be applied depending on other utilization purposes of time-series data.

A pre-processing technology for lump-sum processing and problems with the existing technology are described below.

The application of various high-performance time-series data pre-processing schemes does not essentially improve the quality of time-series data always. Efficiency of each pre-processing scheme may be different depending on the order in which one or several pre-processing methods are applied to a specific segment of time-series data. Such a change may occur due to a problem attributable to a statistical distribution that is unique to collected data. Nevertheless, in general, a pre-processing scheme is uniformly applied to most of time-series data. This may unintentionally degrade the quality of data.

For example, the influence of each pre-processing technology may be different depending on the order in which each pre-processing technology is applied to various segments and the influence of data on a specific problem region. In order to solve such a problem, a fine approach is required. A pre-processing strategy needs to be adjusted by considering the feature of each segment and the use of data. Optimal data quality will be obtained by recognizing the feature of each data set and sequentially applying pre-processing while considering the existing problems.

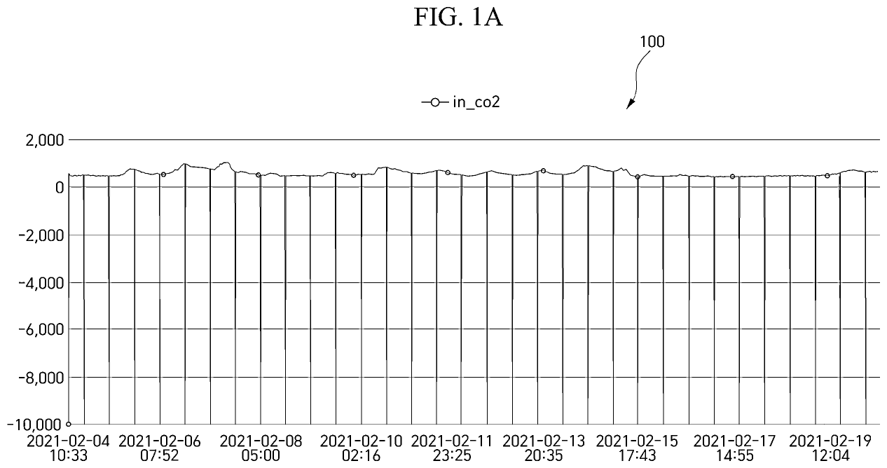

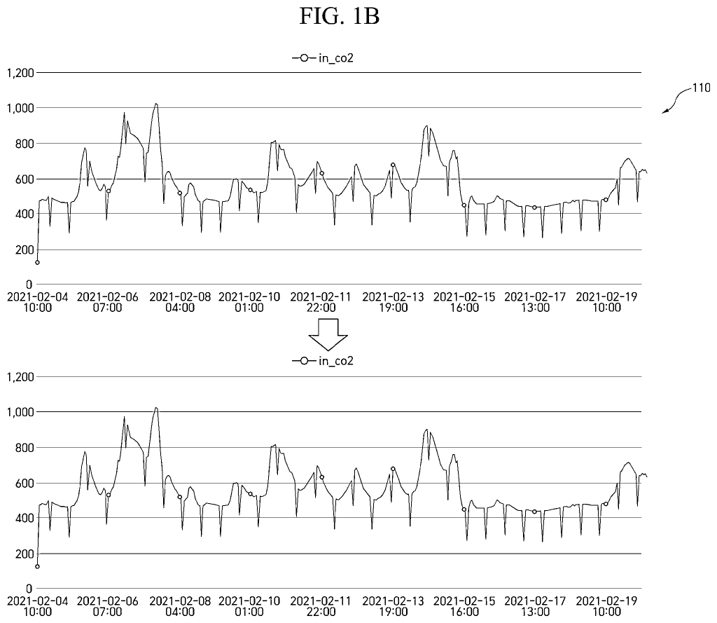

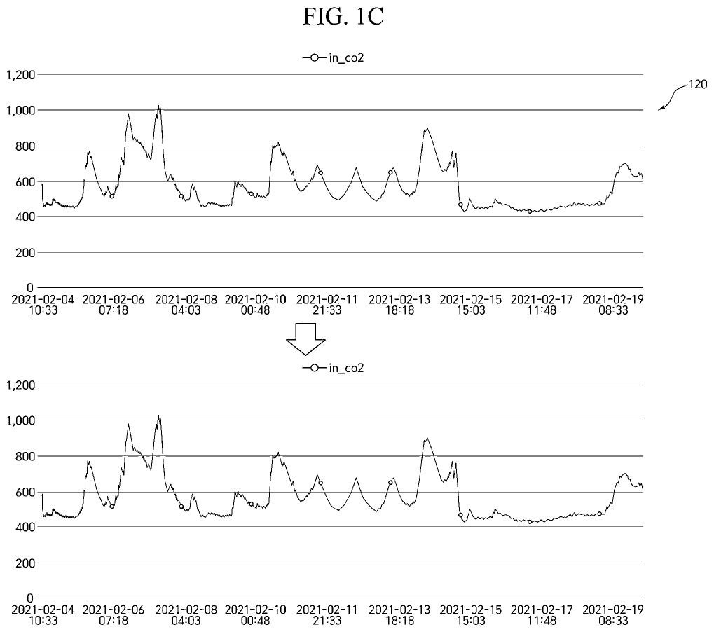

FIG. 1A is a diagram illustrating original data 100 including periodical abnormal-value data. FIG. 1B is a diagram illustrating the results 110 of the application of a task for sequentially applying down-sampling and abnormal value detection pre-processing processes on the original data in FIG. 1A. FIG. 1C is a diagram illustrating the results 120 of the application of a task for sequentially applying abnormal value detection and down-sampling pre-processing processes on the original data in FIG. 1A.

For example, when time-series data including periodical abnormal values are present as illustrated in FIG. 1A, as illustrated in FIG. 1B, a person who uses the data may not recognize that the data include severe error data at all if the person uses the data after purifying the data through down-sampling. Although an abnormal value is detected (outlier detection) in such data, proper pre-processing is not performed because it is difficult to find abnormal data. Therefore, as illustrated in FIG. 1C, if an abnormal value is first detected in data and the data is down-sampled, the data may be pre-processed into normal data.

However, such an order is not always correctly applied. For example, if data having a quite different problem depending on an interval are present, it is assumed that the data include a first interval in which the quality of data needs to be improved by removing an abnormal value and interpolating the data, a second interval that needs to be fully removed instead of interpolation because the second interval includes a long loss value, and a third interval having a normal state. Furthermore, the data of these intervals are time-series data that are continuously connected. Such a case is a situation which may commonly occur upon data collection using an IoT sensor or a data sensor. In this case, it is necessary to first segment the intervals of unnecessary data and necessary data, to boldly discard the interval of the unnecessary data, to determine a degree that the interval of the necessary data has been lost, and to perform proper interpolation on the necessary data. Furthermore, pre-processing needs to be performed on a normal interval properly and conservatively. To this end, it is necessary to differentially apply proper pre-processing to different time-series intervals.

In order to solve such a problem, in an embodiment of the present disclosure, three pre-processing data pipelines are basically applied. First, time-series data that are recorded along the lapse of time are segmented along a time axis so that individual pre-processing can be applied to the time-series data. Furthermore, optimal pre-processing may be applied to the time-series data through a flexible combination of several time-series data processing unit modules. Furthermore, there is proposed a pre-processing method for the utilization of multiple types of time-series data in addition to single time-series data.

Furthermore, in an embodiment of the present disclosure, if time-series data are used in applications (e.g., analysis, learning, and monitoring) for various purposes by processing and converting the time-series data, time-series data having the best quality may be constructed through pre-processing by considering the feature of data that are described along the lapse of time.

In a process of obtaining the results of inference using pre-processed time-series data, the existing representative method for obtaining the results of inference using small and incomplete data includes machine learning (i.e., traditional ML) and transfer learning. In a conventional technology, a model may be generated based on existing big data, and the generated model may be partially re-trained by using new data.

However, such partial re-training requires an additional resource, and good inference results cannot be obtained if a distribution of new data is different. Furthermore, since such a case also corresponds to re-training, a learning resource not inference is required. A learning resource requires more resources than the inference resource. Furthermore, in the conventional technology, there is no attempt to split up the time by considering the specialty of time-series data as in an embodiment of the present disclosure.

Furthermore, if a predictive model is generated by learning incomplete data, uncertainty is great, and it is difficult to achieve high performance. That is, incomplete data need to be used as much as possible for learning because the least data need to be secured for the learning. In this case, if a method of deleting the incomplete data is applied, there is a problem in that a large amount of time-series data has to be deleted because the lapse of time is broken in the time-series data. Furthermore, if a method of supplementing lost data is applied, a small amount of data may be supplemented and used by inferring the interval of the small amount of data if the small amount of data is lost. However, there is a problem in that it is difficult to use the lost data as data if the length interval of the lost data is long.

In order to solve such a problem, an electronic device and a method of generating a predictive model based on the classification of patterns of time-series data according to embodiments of the present disclosure can obtain the results of inference by using the existing generated model if it is difficult to train a predictive model because time-series data are not sufficient.

In particular, in an embodiment of the present disclosure, a learning model is generated by subdividing the existing time-series big data having similar characteristics based on a time interval, a pattern characteristic, etc. Thereafter, a predictive model that has been trained by using data having the most similar pattern, among data patterns having the same time interval, is used although the inference of new data is subsequently performed.

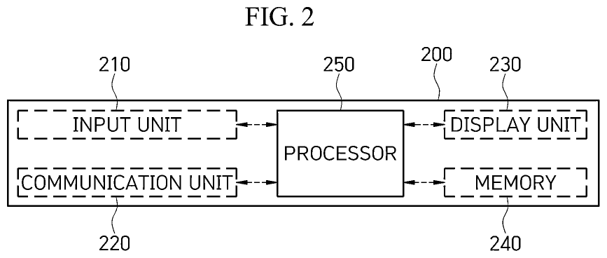

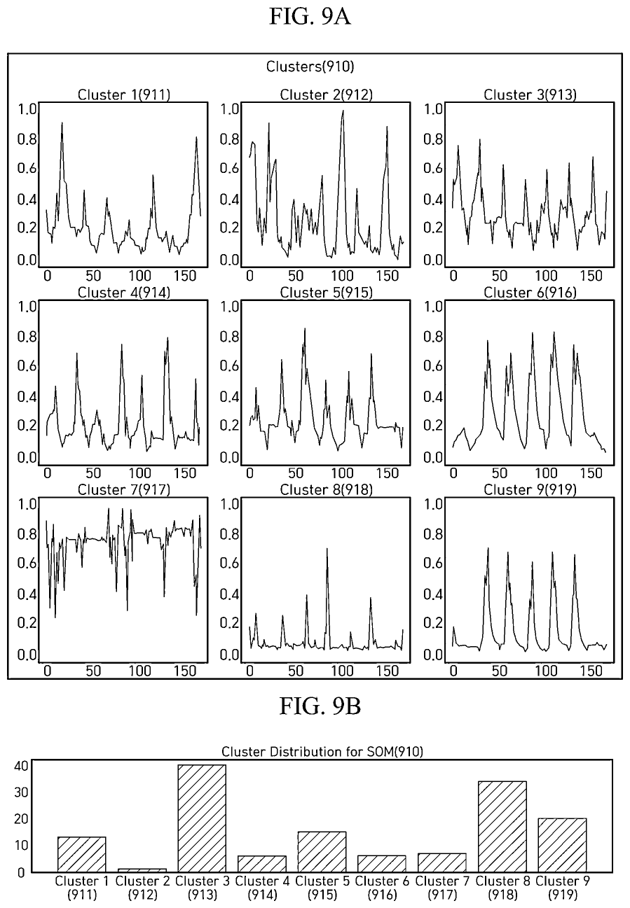

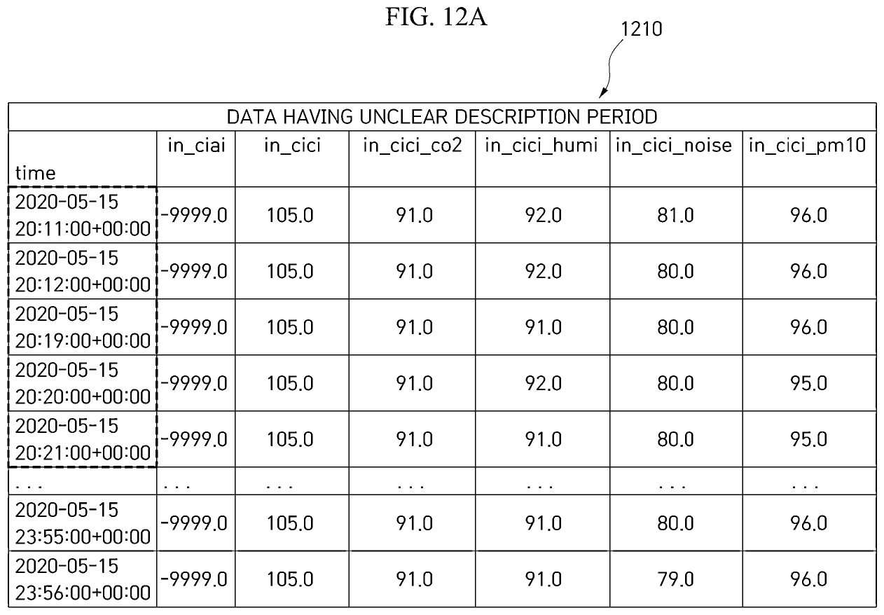

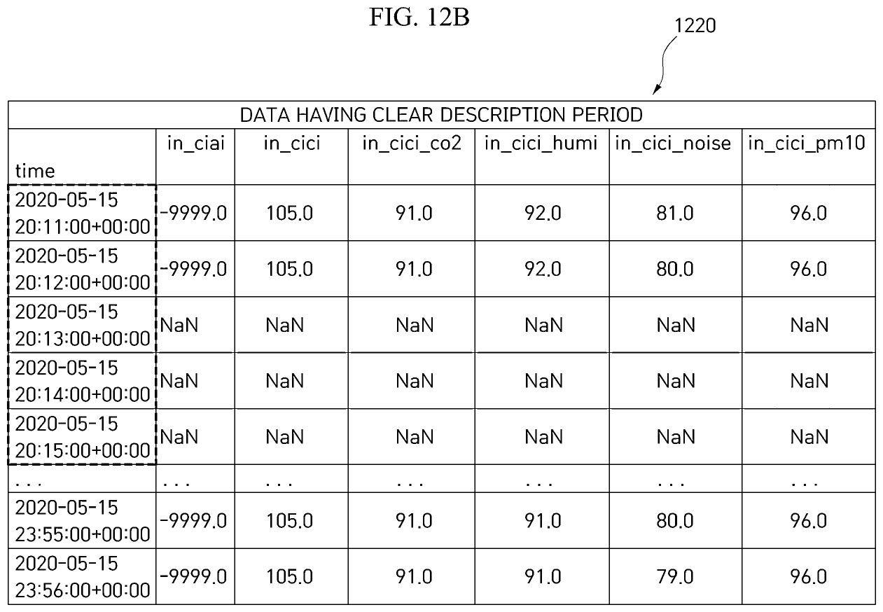

Hereinafter, an electronic device and a method of the electronic device generating a predictive model based on the classification of patterns of time-series data to which a pre-processing pipeline has been applied according to embodiments of the present disclosure are described with reference to FIGS. 2 to 21. In this case, a process of building and applying a pre-processing pipeline in an embodiment of the present disclosure is described with reference to FIGS. 2 to 8. A process of generating a predictive model based on the classification of patterns of pre-processed time-series data in an embodiment of the present disclosure is described with reference to FIGS. 9A and 9B to 11. Finally, embodiments of pre-processing according to individual pre-processing modules in an embodiment of the present disclosure are described with reference to FIGS. 12A and 12B to 21.

FIG. 2 is a block diagram illustrating a construction of an electronic device 200 according to an embodiment of the present disclosure.

The electronic device 200 according to an embodiment of the present disclosure includes an input unit 210, a communication unit 220, a display unit 230, memory 240, and a processor 250.

The input unit 210 generates input data in response to a user input to the electronic device 200. The user input may include a user input relating to time-series data to be processed by the electronic device 200, a user input for building a pre-processing pipeline, a selection input for a built pre-processing pipeline, a user input relating to a data supplementation condition, or a user input relating to at least one omission data processing method of processing omission data. The input unit 210 includes at least one input means. The input unit 210 may include a keyboard, a key pad, a dome switch, a touch panel, a touch key, a mouse, and a menu button.

The communication unit 220 performs communication with an external device, such as various sensors, a server, or a data collection device in order to receive data. The communication unit 220 may include both a wired communication module and a wireless communication module. The wired communication module may be implemented as a power line communication device, a telephone line communication device, cable home (MoCA), Ethernet, IEEE1294, an integrated wired home network, or an RS-485 controller. Furthermore, the wireless communication module may be constructed as a module for implementing a function, such as a wireless LAN (WLAN), Bluetooth, an HDR WPAN, UWB, ZigBee, impulse radio, a 60 GHz WPAN, binary-CDMA, a wireless USB technology, a wireless HDMI technology, 5th generation (5G) communication, long term evolution-advanced (LTE-A), long term evolution (LTE), or wireless fidelity (Wi-Fi).

The display unit 230 displays data according to an operation of the electronic device 200, a stored model, and the results of analysis and prediction. The display unit 230 may display received time-series data, a construction of a pre-processing pipeline and an interface for the construction, drawn time-series data, a constructed cluster, a pattern classification model, a predictive model, and the results of prediction using the model. Furthermore, the display unit 230 may display display data (e.g., a screen for setting a data supplementation condition) that are necessary to select data based on the data supplementation condition and a screen for displaying the results of the processing of data. Alternatively, the display unit 230 may display display data that are necessary to process omission data, for example, a screen for processing abnormal data among collected data, a screen for identifying information on omission data, screen for receiving a user input, and a screen for displaying the results of the processing of data. The display unit 230 includes a liquid crystal display (LCD), a light emitting diode (LED) display, an organic light-emitting diode (OLED) display, a micro electro mechanical systems (MEMS) display, and an electronic paper display. The display unit 230 may be implemented as a touch screen in combination with the input unit 210.

The memory 240 stores operating programs of the electronic device 200. In this case, the memory 240 commonly refers to a nonvolatile storage device that retains information stored therein although power is not supplied to the nonvolatile storage device and a volatile storage device. For example, the memory 120 may include NAND flash memory such as a compact flash (CF) card, a secure digital (SD) card, a memory stick, a solid-state drive (SSD), and a micro SD card, a magnetic computer memory device such as a hard disk drive (HDD), and an optical disc drive such as CD-ROM and DVD-ROM.

The memory 240 may store time-series data collected from an external device, or may store a pre-processing module for building a pre-processing pipeline, information relating to a connection relation, data relating to a data supplementation condition, information relating to abnormal data, and information relating to an omission data processing method. Furthermore, the memory 240 may store generated pattern classification models and predictive models in a repository by dividing the generated pattern classification models and the predictive models. Furthermore, the memory 240 may store information relating to a model that has been trained to identify at least one omission data processing method based on information on omission data.

The processor 250 may control at least another component (e.g., a hardware or software component) of the electronic device 200 by executing software, such as a program, and may perform various data processing or operations.

The processor 250 may build a pre-processing pipeline, may apply the pre-processing pipeline to time-series data, may train a pattern classification model and a predictive model based on pre-processed time-series data, and may store the pattern classification model and the predictive model in repositories, respectively. Furthermore, the processor 250 may predict feature information of newly received time-series data by applying a corresponding predictive model to the newly received time-series data after the newly received time-series data are classified as a corresponding cluster through a pattern classification model.

In an embodiment of the present disclosure, for the clustering and prediction of data and in order to process data according to a data supplementation condition, the processor 250 may use at least one of machine learning, a neural network, or a deep learning algorithm as an artificial intelligence algorithm. For example, at least one of machine learning, a neural network, or a deep learning algorithm may be used as the artificial intelligence algorithm. An example of the neural network may include models, such as a convolutional neural network (CNN), a deep neural network (DNN), and a recurrent neural network (RNN).

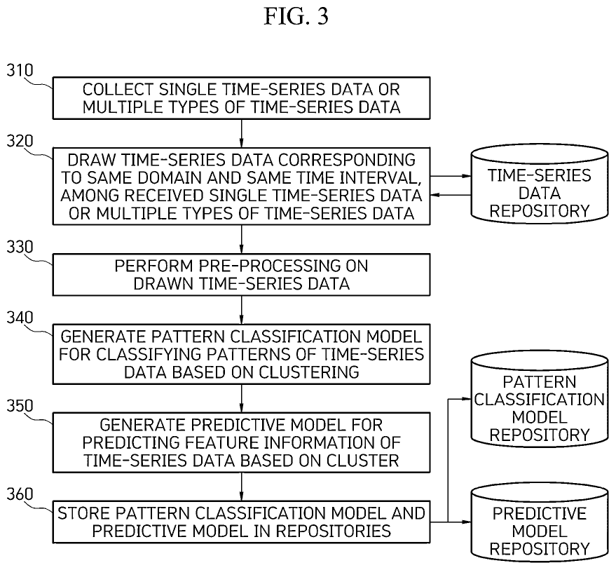

FIG. 3 is a flowchart of a method of generating a predictive model based on the classification of patterns of time-series data to which a pre-processing pipeline has been applied according to an embodiment of the present disclosure. In this case, steps illustrated in FIG. 3 may be understood as being performed by the electronic device 200 in FIG. 2.

In an embodiment of the present disclosure, the assumption that many time-series data collected in the same domain are present is required. That is, in an embodiment of the present disclosure, time-series data (e.g., time-series data 1 to time-series data N) that have been previously collected in a specific domain are stored in a time-series data repository. In this case, the time-series data 1 to the time-series data N may be collected in the same domain or different domains, and are time-series data collected at a plurality of places. Furthermore, only one feature value is not essentially the target of time-series data that are collected in the present disclosure, and the time-series data may be collected with respect to a plurality of feature values.

For example, it is assumed that a problem of bad smell in a smart farm is solved. It is assumed that a smart farm A to a smart farm Y have collected data, such as carbon dioxide, hydrogen sulfide, or fine dust, for a long time and the smart farm A to the smart farm Y have collected data, such as related weather or fine dust, in cities in which the smart farm A to the smart farm Y are present, respectively.

A problem for predicting a future value of hydrogen sulfide at a place A may be solved by using the existing common method, such as machine learning or transfer learning.

However, if related data have just started to be collected at a new place Z, a predictive model corresponding to the place Z cannot be present. Furthermore, it is difficult to generate the predictive model corresponding to the place Z because a lot of time is taken to collect the data. For example, if a large amount of data is not transmitted from a place E to a cloud, there is a difficulty in generating a predictive model corresponding to the place E although a long time is taken.

Accordingly, in an embodiment of the present disclosure, in order to solve the problem, a predictive model to be applied for the analysis of time-series data that are started to be collected at a new place may be generated and applied by actively using time-series data (e.g., the smart farms A to Z) collected in the same domain.

First, the processor 250 receives single time-series data or multiple types of time-series data that are collected in a specific domain (310). In this case, the meaning of the single or multiple types is not related to whether a variable that constructs the time-series data is a single variable or multiple variables. That is, the single variable or the multiple variables are related to the construction of a variable within single time-series data. This is a concept that is different from the concept of the multiple types of time-series data. An embodiment of the present disclosure is targeted on not only single time-series data that are collected from one piece of situation information, but multiple types of time-series data that are collected from multiple types of situation information. As a simple example, multiple types of time-series data may be a construction of single time-series data that are collected in each of multiple spaces (e.g., a class A, a class B, and a class C) that are divided in a school. As another example, multiple types of time-series data may be a construction of single time-series data that are collected in each of an area A, an area B, and an area C that are divided in a city.

Next, the processor 250 draws time-series data corresponding to the same domain and the same time interval, among the received single time-series data or multiple types of time-series data (320).

In the step of drawing the previously collected time-series data, the processor 250 draws all of time-series data that belong to the same domain and that are included in the same time interval, among time-series data that are collected at various places (e.g., places A to Y). This is for finally extracting at least one time-series pattern which may represent a corresponding domain.

As an embodiment, in an embodiment of the present disclosure, time-series data that correspond to the same domain and that are included in the same time interval, among time-series data at a plurality of different places which have been previously collected in a specific domain, may be drawn. That is, in an embodiment of the present disclosure, it is premised that time-series data, that is, a target to be drawn, have not been collected at the same place, but have been collected a plurality of different places.

Furthermore, the processor 250 may draw time-series data by combining conditions for a plurality of time intervals, among time intervals corresponding to time-series data that have been previously collected in a specific domain. That is, the time-series data need to be drawn by making different several time combinations because the time-series data often clearly show different patterns depending on their time features. For example, several conditions, such as 3 a.m. to 10 p.m. as a first condition and a weekday (or a weekend, a holiday, or a non-holiday) as a second condition, may be combined. Accordingly, time-series data that are drawn may be different.

Likewise, even in a prediction step described later, corresponding time zones of time-series data that are input to a predictive model need to be identically selected or applied.

As described above, in an embodiment of the present disclosure, time-series data that are collected corresponding different places within the same domain and the same time interval are collected into one. This is different from the existing technology in which one independent data are constructed based on the same place, space, device, sensor, and characteristics.

Next, the processor 250 performs pre-processing on the drawn time-series data (330). The pre-processing of the time-series data is for constructing a model by using only time-series data that are suitable for the generation of the model, among the drawn time-series data.

In such a pre-processing process, not time-series data that are collected from the same space, device, or sensor, but time-series data having the same domain, that is, similar features are collected and used to generate a model. Accordingly, it is necessary to resolutely delete data that are large in the amount and that are not used due to low quality.

As an embodiment, in the present disclosure, pre-processing may include at least one of first pre-processing for purifying drawn time-series data based on a predetermined reference period, second pre-processing for processing time-series data or individual time-series data included in a time interval having an abnormal value, among drawn time-series data, as a loss value, and third pre-processing for performing exclusion processing on time-series data included in a time interval in which time-series data having a preset first threshold or more have been lost and performing recovery processing on time-series data included in a time interval in which time-series data less than a second threshold smaller than the first threshold have been lost by supplementing the time-series data. In this case, the third pre-processing is for supplementing data having a small degree of individual data lost, and does not greatly influence the final results although specific data are excluded or recovered because the data have a short basic unit and are prepared from several sources in combination. A pre-processing process that is performed by each pre-processing module is described more specifically with reference to drawings subsequent to FIG. 12A.

In particular, in an embodiment of the present disclosure, further to performing pre-processing on all of time-series data with respect to a single pre-processing module, a pre-processing pipeline in which a plurality of pre-processing modules has been combined is constructed and pre-processing is performed on time-series data. According to such a characteristic, according to an embodiment of the present disclosure, pre-processing may be performed on multiple types of time-series data in addition to single time-series data.

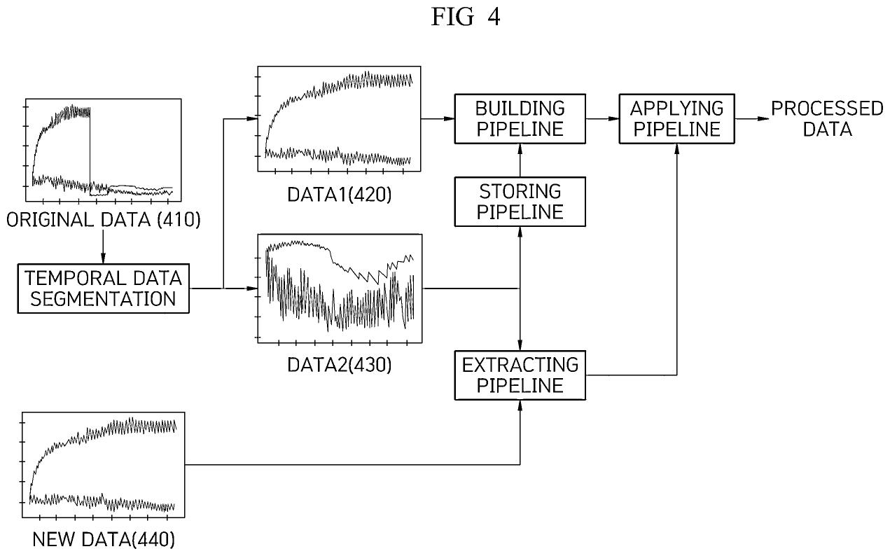

FIG. 4 is a diagram for schematically describing a process of building a pre-processing pipeline according to an embodiment of the present disclosure.

In an embodiment of the present disclosure, a case in which a case in which the quality of data is degraded when the same pre-processing method is applied to all intervals of single time-series data or multiple types of time-series data occurs is described as a premise. That is, time-series data that have been accumulated for a long time need to be properly processed because the time-series data include abnormal data having various pattern due to different causes along the lapse of time.

Therefore, in an embodiment of the present disclosure, time-series data are segmented into time intervals, and a pre-processing pipeline most suitable for the segmented time-series data is built. Furthermore, the quality of the segmented time-series data is improved by applying the built pre-processing pipeline. Pre-processing pipeline built as described above may be identically applied when new and similar data are input. Furthermore, the built pre-processing pipeline may be segmented manually or automatically and applied.

Referring to FIG. 4, original data 410 are segmented into data1 (420) and data2 (430) based on their features, and pre-processing pipelines are adaptively built and stored with respect to the data, respectively. Thereafter, when new time-series data 440 having a similar pattern or problem are input, the new time-series data may be pre-processed by drawing an optimal pre-processing pipeline, among a plurality of built pre-processing pipelines, and applying the optimal pre-processing pipeline to the new time-series data.

More specifically, in an embodiment of the present disclosure, the processor 250 may segment the entire time interval of time-series data into a plurality of time intervals, and may build a pre-processing pipeline by applying at least one of the same type of pre-processing module and different types of pre-processing modules to a time interval to be pre-processed, among the segmented time intervals. Furthermore, the time-series data may be pre-processed by operating the built pre-processing pipeline.

Specifically, in the pre-processing process, different processing needs to be performed on an interval having a problem that is not included in the entire time interval of the time-series data. The reason for this is that the time-series data may have degraded quality if the same type of pre-processing scheme is sequentially applied to the time-series data because the cause and aspect of a data error in the time-series data may be different along the lapse of time. Furthermore, in view of the feature of data to be processed, the amount of the data is proportionally increased as the time interval of the data is increased. Therefore, it may be inefficient to identically apply the pre-processing of time-series data to an interval of data not having a problem. Accordingly, in an embodiment of the present disclosure, a time interval is segmented by considering the specialty of time-series data, which depends on time, and pre-processing modules are differentially applied to the time-series data.

In an embodiment of the present disclosure, an individual pre-processing module may be applied to each segmented time interval, and a different pipeline may also be applied to each segmented time interval.

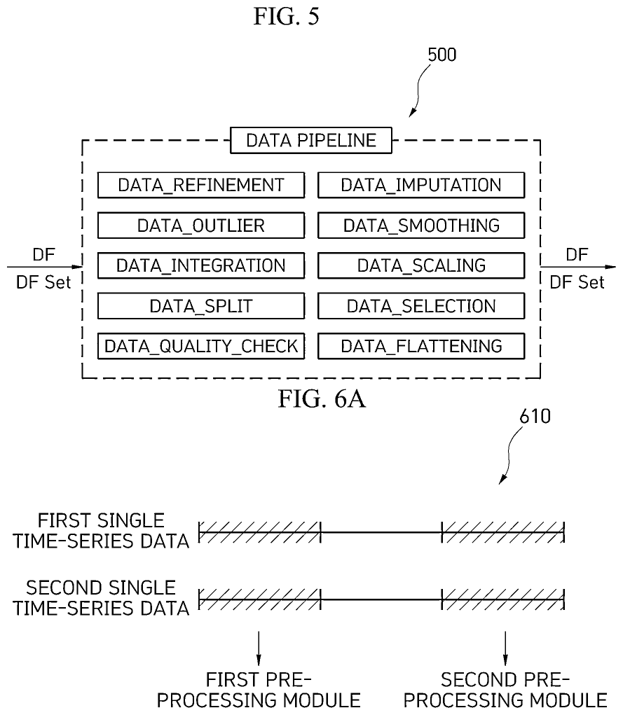

FIG. 5 is a diagram for describing a process of building a pre-processing pipeline 500 in an embodiment of the present disclosure.

Each time-series datum may require one type or several other types of pre-processing with respect to a problematic interval. Furthermore, the quality of the time-series datum may be sensitively different depending on the order in which each pre-processing technology is applied to the time-series datum. To this end, an embodiment of the present disclosure proposes a method of connecting several pre-processing modules to a pipeline and sequentially applying the pipeline.

As an embodiment, if N selectable pre-processing modules are present, M pre-processing methods may be applied in order to build a pre-processing pipeline (M≤N). Furthermore, in a method of building M pipelines, mPr possible pipelines may be built.

It is preferred that the pre-processing pipeline is automatically built, but may be manually built depending on a user's selection. For example, in an embodiment of the present disclosure, if a plurality of built pre-processing pipelines is present, the processor may select a pre-processing pipeline having the smallest difference between each of data that have been pre-processed by the plurality of pre-processing pipelines, respectively, and correct answer data that have been previously prepared. That is, if problematic data and correct answer data that have been properly converted from the problematic data can be secured, a pre-processing pipeline having the smallest difference between data that have been converted through the most suitable pre-processing and the correct answer data, among pre-processing pipelines consisting of a plurality of permutations, may be automatically selected.

As another embodiment, although correct answer data cannot be secured, a pre-processing pipeline that is most suitable for a recognized situation may be selected and applied by recommending the pre-processing pipeline through a detector that recognizes an overall problem situation of time-series data.

In the case of manual application, a user may build and apply a pre-processing pipeline by directly checking and selecting a plurality of pre-processing modules.

In general, a pre-processing pipeline may be built by using the above method, but different pre-processing needs to be considered depending on a problem that will be actually solved. For example, if time-series data are now collected in order to confirm a problem situation itself of sensor data, this may make difficult to confirm the problem situation if data interpolation or filtering-based pre-processing is used. However, for learning using corresponding data, it is preferred that the corresponding data need to be prepared in a form in which the corresponding data can be used as much as possible by removing problem situation data or well supplementing data having a problem situation. As described above, a pre-processing pipeline needs to be differently built with respect to the same data depending on its utilization purpose.

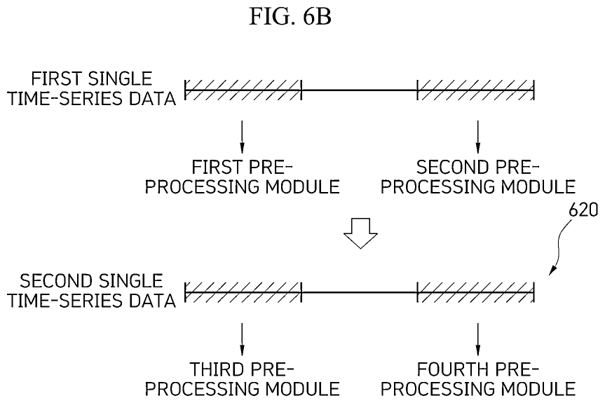

In an embodiment of the present disclosure, a pre-processing pipeline for multiple types of time-series data may be built. FIG. 6A is a diagram for describing an example in which a pre-processing module is applied to multiple types of time-series data in an embodiment of the present disclosure. As an embodiment, the processor may apply a first pre-processing module to a first pre-processing target time interval of first and second single time-series data that constitute multiple types of time-series data. Furthermore, the processor may apply a second pre-processing module to a second pre-processing target time interval subsequent to the first pre-processing target time interval of the first and second single time-series data. That is, in an embodiment of the present disclosure, a pre-processing pipeline may be built so that the same pre-processing module is applied to the same time interval of the multiple types of time-series data (610).

FIG. 6B is a diagram for describing another example in which a pre-processing module is applied to multiple types of time-series data in an embodiment of the present disclosure. As another embodiment, the processor applies a corresponding pre-processing module to each pre-processing target time interval of first single time-series data that constitute multiple types of time-series data. Furthermore, after the application of the pre-processing module to the first single time-series data is completed, the processor applies a pre-processing module corresponding to each pre-processing target time interval of second single time-series data that constitute multiple types of time-series data. That is, in an embodiment of the present disclosure, a pre-processing pipeline may be built so that each pre-processing module is applied to each pre-processing target time interval of single time-series data that have been determined according to a predetermined order with respect to multiple types of time-series data (620).

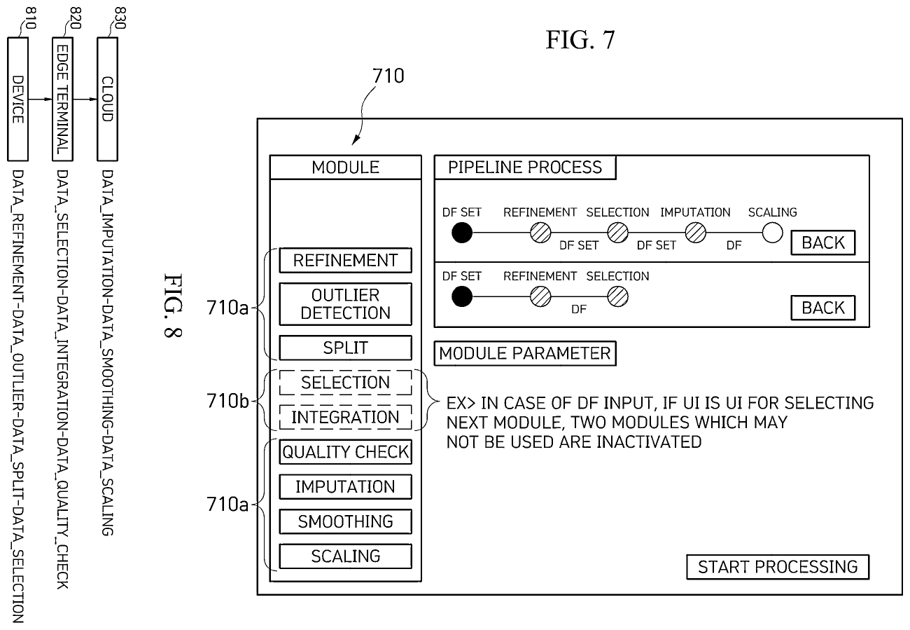

FIG. 7 is a diagram for describing a process of building a pre-processing pipeline depending on single time-series data or multiple types of time-series data in an embodiment of the present disclosure.

As an embodiment, the processor may build a pre-processing pipeline based on input and output feature information of a pre-processing module and input and output feature information between a previous pre-processing module and a next pre-processing module.

In this case, the processor may selectively output pre-processing modules which are applicable depending on whether input time-series data correspond to a single type or multiple types (710, 710a, and 710b). Furthermore, the processor may select and apply a first pre-processing module, among the output pre-processing modules. Furthermore, the processor may selectively output the pre-processing modules that are applicable after the first pre-processing module depending on whether time-series data output by the first pre-processing module correspond to a single type or multiple types, and may select and apply a second pre-processing module, among the output pre-processing modules.

For example, if pre-processing modules are for Refinement, Outlier Detection, Imputation, Smoothing, and Scaling, single time-series data are output as multiple types of time-series data when the single time-series data are input, and multiple types of time-series data are output as multiple types of time-series data when the multiple types of time-series data are input. As another example, if data are split, multiple types of data are unconditionally output. The selection pre-processing module receives and outputs multiple types of data. The integration pre-processing module receives only multiple types of data and outputs single data. The data quality check pre-processing module receives single data, deletes only an unnecessary feature from the single data, and outputs only single data. As described above, in an embodiment of the present disclosure, in order to perform pre-processing on multiple types of time-series data in addition to single time-series data, a pre-processing pipeline is built by confirming input and output features of a pre-processing module depending on a single type or multiple types. An example of such an input and output relation may be represented as illustrated in Table 1.

TABLE 1

| Data Pipeline | Input | | Output |
|---|---|---|---|
| data_refinement (Refinement) | DF | → | DF |
| | DF Set | → | DF Set |
| data_outlier (Outlier Detection) | DF | → | DF |
| | DF Set | → | DF Set |
| data_imputation (Imputation) | DF | → | DF |
| | DF Set | → | DF Set |
| data_smoothing (Smoothing) | DF | → | DF |
| | DF Set | → | DF Set |
| data_scaling (Scaling) | DF | → | DF |
| | DF Set | → | DF Set |
| data_split (Split) | DF | → | DF Set |
| | DF Set | | |
| data_selection (Selection) | DF Set | → | DF Set |
| data_integration (Integration) | DF Set | → | DF |
| data_quality_check (Quality Check) | DF | → | DF |
| data_flattening (Flatten) | DF | → | DF |

After a plurality of pre-processing pipeline is built as described above, when receiving new single or multiple types of time-series data, the processor may select at least one of previously built pre-processing pipelines, and may apply the selected pre-processing pipeline to any one interval, among segmented intervals of the time-series data. That is, the size of the time-series data is increased in proportion to the lapse of time. Furthermore, if the length of the time is long, the time of pre-processing is also increased that much. If specific time-series data show errors and aspects having similar patterns, a pre-processing pipeline construction and parameter that have been most optimized for sample data may be applied to all time-series data without any change. Accordingly, in an embodiment of the present disclosure, a pre-processing pipeline that has been most optimized for data in a specific time interval can be built, and may be identically applied to even newly received time-series data that are expected to show the same feature.

FIG. 8 is a diagram for describing a process of pre-processing time-series data based on a physical characteristic interval in an embodiment of the present disclosure.

As an embodiment, in the present disclosure, time-series data may be pre-processed by segmenting a built pre-processing pipeline based on a physical characteristic interval. In this case, the physical characteristic interval means an interval in which one built pre-processing pipeline is segmented and applied based on a physical characteristic of a device, such as a terminal or a server.

For example, in FIG. 8, when one pre-processing pipeline to be applied is selected, a device 810, such as a smartphone, performs a pre-processing process in order of the pre-processing modules data_refinement, data_outlier, data_split, and data_selection, and transmits the results of the pre-processing process to an edge terminal 820. The edge terminal 820 performs pre-processing in order of pre-processing modules data_selection, data_integration, and data_quality_check, and transmits the results of the pre-processing to a cloud 830. Finally, the cloud finally completes the pre-processing process by performing pre-processing in order of the pre-processing modules data_imputation, data_smoothing, and data_scaling. As described above, in an embodiment of the present disclosure, one pre-processing pipeline is segmented, and pre-processing is performed only on the segmented pre-processing pipeline in each physical characteristic interval so that pre-processing according to the pre-processing pipeline can finally operate more rapidly and stably.

Next, the processor 250 generates a pattern classification model for classifying representative patterns of the pre-processed time-series data (340), generates a predictive model as a data cluster according to the patterns (350), and stores the generated pattern classification model and the predictive model in repositories, respectively (360).

In this case, in an embodiment of the present disclosure, overall scheduling for generating the pattern classification model and the predictive model may be controlled. In particular, the pattern classification model and the predictive model that are generated based on the time-series data may be actively updated over time because the models are greatly influenced by the lapse of time. To this end, the processor 250 may generate and update a model periodically or aperiodically.

Specifically, the processor 250 generates the pattern classification model for classifying the patterns of time-series data based on the clustering of the pre-processed time-series data (340). FIGS. 9A and 9B are diagrams illustrating examples of the results of the classification of patterns of time-series data in an embodiment of the present disclosure.

In an embodiment of the present disclosure, a pattern classification model for classifying data flows of input time-series data may be generated. In this case, a clustering algorithm, such as a K-MEANS algorithm or a self organizing map (SOM) algorithm, may be applied to the pattern classification model.

As an embodiment, in the present disclosure, a pattern classification model may be generated so that the patterns of time-series data are classified by a pre-designated clustering number or an automatically adjusted clustering number.

In this case, if the processor 250 generates a pattern classification model by automatically adjusting a clustering number, for example, the processor 250 segments all time intervals of collected time-series data into a plurality of detailed time intervals. In this case, detailed time intervals may be segmented based on semantic information. For example, time-series data that are collected in schools A to Z may be segmented into detailed time intervals, such as learning start and end times, a lunch time, and a break time.

Thereafter, the processor 250 segments feature values (e.g., an air quality value, a temperature, and humidity) of the time-series data into a plurality of detailed feature intervals.

Thereafter, the processor 250 groups time-series data having a detailed time interval and a detailed feature interval matched. In this case, the processor 250 may group the time-series data having the detailed time interval and the detailed feature interval matched, based on the number of peak values of feature values in all the time intervals and the peak values.

Furthermore, the processor 250 groups the grouped time-series data as a cluster based on a degree of the matching (e.g., the number of matching intervals or a matching ratio) between each detailed time interval and each detailed feature interval. The processor 250 may determine a plurality of groups that have been generated as described above as a clustering number.

The existing clustering model for pattern classification may be primarily used for such a pattern classification model without any change, or a separate pattern classification model for classifying the patterns of time-series data may be generated and applied based on drawn time-series data and a label corresponding to the drawn time-series data.

Examples of FIGS. 9A and 9B illustrate the results of drawn (pre-processed) time-series data that have been input to the pattern classification model and the results of the time-series data that have been classified into representative patterns 910 (911 to 919) of 9 clusters.

Next, the processor 250 generates predictive models for predicting feature information of the drawn time-series data, based on clusters generated as the results of the clustering of the time-series data (350).

As an embodiment, the processor 250 may generate the predictive models having a number corresponding to each of all clusters that are generated as the results of the clustering. If the 9 clusters are generated as illustrated in the examples of FIGS. 9A and 9B, the processor 250 may generate 9 predictive models for corresponding data clusters, respectively.

As another embodiment, the processor 250 may generate the predictive models having a number corresponding to upper n (n is a natural number) selected clusters each having a large number of time-series data included in each of all the clusters generated as the results of the clustering, and may generate a pattern classification model again based on a cluster that is selected to correspond to the number of generated predictive models.

In the examples of FIGS. 9A and 9B, the processor 250 may generate 3 predictive models by using only 3 (Nos. 3, 8, and 9 clusters) cluster data that have been checked as major representative patterns. For example, the processor 250 may select only upper n clusters each having a large number of time-series data, among the clusters. In this case, the processor 250 may exclude a cluster including time-series data having a number less than a reference value.

In this case, the pattern classification model generated in step 340 classifies the input time-series data into 9 patterns, and cannot be thus used. Accordingly, in an embodiment of the present disclosure, the processor 250 may generate may separately generate a pattern classification model for classifying only the 3 patterns again. In this case, the pattern classification model may be trained by using the time-series data included in clusters corresponding to the 3 main patterns and label values thereof.

Next, the processor 250 stores the generated pattern classification model and the predictive model in repositories, respectively (360).

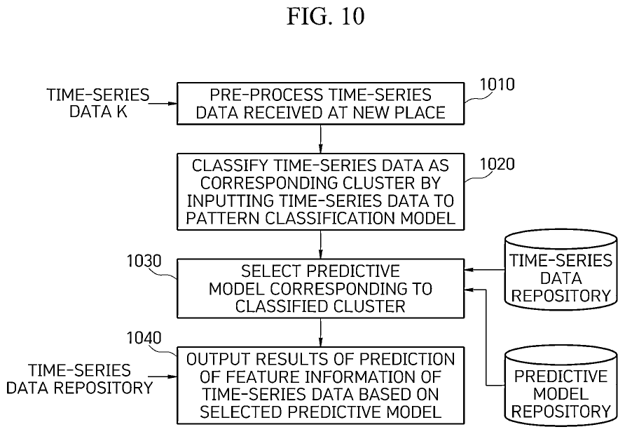

FIG. 10 is a diagram for describing contents in which the results of the prediction of new time-series data are output in an embodiment of the present disclosure.

As described above, in the state in which the pattern classification model and the predictive model have been stored in the repositories based on the time-series data that have been previously collected, when receiving time-series data collected at a new space Z, the processor 250 may cluster the time-series data and output the results of the prediction of feature information of the time-series data.

First, when receiving time-series data collected at a new place, the processor 250 pre-processes the received time-series data (1010). In this case, the collected time-series data have the same domain as the domain of time-series data that have been drawn in a learning process. The pre-processing method in FIGS. 4 to 9A and 9B may be applied to the pre-processing process.

Next, the processor 250 classifies the received time-series data as a corresponding cluster by inputting the received time-series data to a pattern classification model (1020). In this case, the pattern classification model that is applied may be a pattern classification model that is generated again based on the drawn time-series data.

In this case, in an embodiment of the present disclosure, a process of verifying whether the arbitrarily received time-series data have been accurately classified as a specific cluster by the pattern classification model may be additionally performed. The verification process may be selectively performed according to an embodiment. The verification process may be performed for each random period or timing or each specific designated period or timing. In this case, the verification process may include inputting the same time-series data to the pattern classification model twice or more. Furthermore, if a first input result and a second input result are the same, the verification may be determined to be successful.

In contrast, if the first input result and the second input result are different from each other, that is, if the pattern classification model first classifies the same time-series data as a first cluster, but subsequently classifies the same time-series data as a second cluster, the verification process may be performed.

To this end, the received time-series data are segmented into a plurality of first unit time intervals, and the output of the time-series data is checked by inputting unit time-series data corresponding to the unit time interval to each pattern classification model multiple times (e.g., 2). As a result of the check, the result values of unit time intervals having the same results are stored. Unit time intervals having different results are segmented into a plurality of detailed second unit time intervals again, and the same process is performed on time-series data included in the plurality of detailed second unit time intervals. However, it is preferred that the segmentation and re-segmentation processes of the unit time interval are performed by a designated number in view of computer resources.

Thereafter, a pattern classification model that is applied to a corresponding place may be trained by assigning a positive weight to an interval that has been determined as a matched interval, among first to N-th unit time intervals of all the time intervals, and a negative weight to an interval that has been determined as a not-matched interval, among the first to N-th unit time intervals. Alternatively, the weight may be assigned based on the statistics or ratio of matched intervals. The weight means a weight for determining time-series data so that the time-series data are classified as a specific cluster in a specific unit time interval.

An embodiment of the present disclosure has an advantage in that the existing pattern classification model that is applied to a new place can be more optimized for time-series data that are collected in the new place through such a learning process.

Next, the processor 250 selects a predictive model corresponding to the classified cluster (1030), and outputs the results of the prediction of feature information of the received time-series data based on the selected predictive model (1040). In this case, in an embodiment of the present disclosure, in generating the results of the prediction of time-series data that are collected at a new place, the results of the prediction of all time-series data that are collected from the past to the present may be generated. Alternatively, an embodiment of the present disclosure may be performed in a form in which clustering is performed on time-series data of the past predetermined interval and time-series data that are received in real time are applied to a predictive model that is selected by the clustering.

The reason why the above predictive model is selected and applied to the time-series data collected at the new place is that the number of time-series data at the new place is not sufficient to the extent that the predictive model can be generated and there may be a good possibility that the feature of newly received time-series data is similar to the feature of the existing drawn time-series data or the feature of the cluster. Accordingly, there is an advantage in that time-series data collected at a new place can be analyzed by applying a predictive model trained by using the existing time-series data.

However, it may not be proper to continuously apply the above-applied predictive model to the generation of the results of the prediction of time-series data collected at a corresponding place due to a new place characteristic.

Accordingly, in an embodiment of the present disclosure, a reference value is generated, and the reference value and values of newly collected time-series data are compared for each unit time. Furthermore, as a result of the comparison, an error may be calculated for each unit time, and all errors may be calculated by summing the error for each unit time. In this case, the mean value of a plurality of (all or random numbers of) time-series data within a cluster corresponding to the predictive model may be applied as the reference value. The mean value means a value that is obtained by converting a feature value according to the time of the plurality of time-series data into a feature value according to the time of one averaged time-series data.

Thereafter, if all the errors are greater than a preset critical error value, a correction process of applying a correction parameter to a plurality of time intervals each having a great error for each specific unit time may be performed. In this case, the correction process may be repeatedly performed when all the errors are equal to or less than the critical error value after the correction.

In an embodiment of the present disclosure, an error that occurs when the existing predictive model is applied to a new place can be minimized through the correction process. Although the existing predictive model is applied, the results of the prediction of time-series data that have been optimized for each place can be generated.

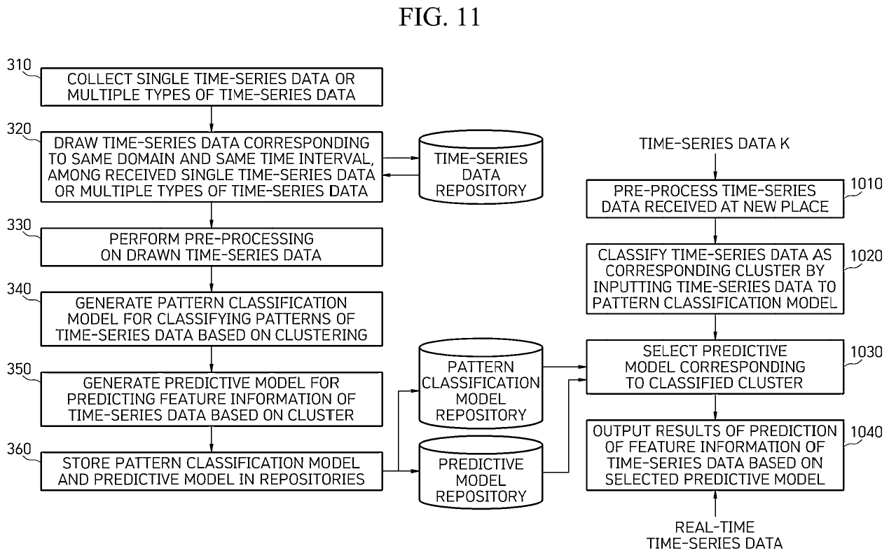

FIG. 11 illustrates the entire flowchart of a method of generating a predictive model according to an embodiment of the present disclosure. The contents described with reference to the flowcharts of FIGS. 3 and 10 have been combined into the entire flowchart.

Hereinafter, in an embodiment of the present disclosure, a pre-processing process for time-series data according to each pre-processing module is more specifically described.

First, as an embodiment, the processor 250 may perform a first pre-processing process of purifying drawn time-series data based on a pre-determined reference period. To this end, the processor 250 may purify the drawn time-series data based on the pre-determined reference period.

As an embodiment, the time-series data show a continuous characteristic. The continuous time-series data may be repeated along the lapse of time or may show a common pattern. Furthermore, the time-series data may have periodicity, and periods thereof may commonly show a pattern in which the periods are common and repeated on the basis of a unit, such as “a time, a day, a week, a month, or a year”.

For example, an indoor temperature simultaneously has daily and year unit periodicities because the indoor temperature is influenced by the revolution and rotation of the earth. Furthermore, in the case of a change in carbon dioxide within the interior of a school, the probability that carbon dioxide may have daily and week unit patterns is high due to a daily work. Carbon dioxide may have year unit periodicity because an indoor window opening pattern is different depending on an outside temperature. Such a pattern plays an important role in the analysis and purification of data, and must be considered when data are used.

FIGS. 12A and 12B are diagrams illustrating examples in which time-series data have been purified based on a reference description period.

As an embodiment, the processor 250 may generate a reference period so that the time stamp of time-series data that are basically used as an input are uniform, but an embodiment of the present disclosure is not essentially limited thereto. The reference period may be set in various ways. For example, the processor 250 may set the reference period by inferring the reference period based on feature information of drawn time-series data, or may set the reference period based on a user's determination or an external parameter.

After the reference period is set, the processor 250 newly sets a time stamp based on the reference period and changes the time-series data so that the time-series data are uniformly described based on the time stamp. In this case, if some data are omitted from the time-series data, the processor 250 may display (e.g., NaN) the omission data so that the omission data are different.

FIG. 12A illustrates time-series data before the time-series data are purified based on a reference period (1210). FIG. 12B illustrates time-series data that have been purified based on the reference period (1220). In this case, the reference period has been set as a 1-minute unit, and the time stamp of the 1 minute unit has been set based on the description period. In this case, data omitted in FIG. 12A are indicated as NaN.

As another embodiment, the processor 250 may perform a second pre-processing process of processing, as a loss value, time-series data or individual time-series data including a time interval having an abnormal value, among drawn time-series data.

As still another embodiment, the processor 250 may perform exclusion processing on time-series data including a time interval in which time-series data having a preset first threshold or more have been lost, and may perform a third pre-processing process of performing recovery processing on time-series data including a time interval in which time-series data having a value less than a second threshold smaller than the first threshold have been lost by supplementing the time-series data.

That is, in an embodiment of the present disclosure, a pre-processing process of deleting and supplementing abnormal data and omission data may be performed.

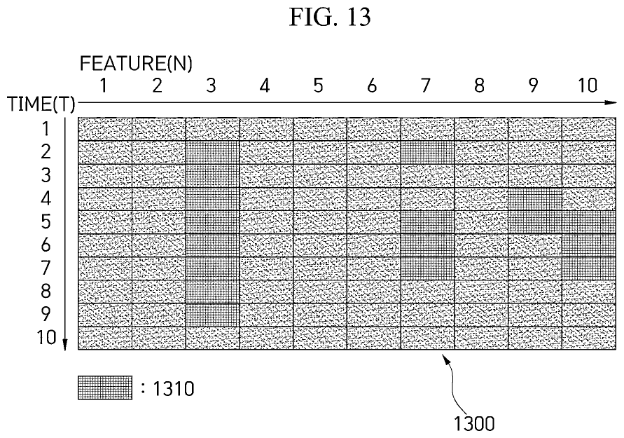

FIG. 13 is a diagram illustrating time-series data 1300 including omission data.

In FIG. 13, the time-series data 1300 have been obtained by tablizing collected data over time T for each feature information (Feature N), and includes 10 pieces of different feature information and 10 times.

Time-series data are analyzed on the premise of integrity, but are frequently omitted or abnormal data occur due to various causes in a process of actually collecting data.

In an embodiment of the present disclosure, omission data are data that cannot be converted and indicated by any method, such as a number or letter, and are comprehensively defined as data that cannot be defined or are not present. The omission data mean data that have not been collected at a corresponding time or data that have been omitted in a process of transmitting collected data to a device, such as a server, although the data have been collected. The value of the omission data may be indicated as an extreme value, such as “−999”, or may be represented in various ways, such as representing a determined letter, as illustrated in “NaN” or “NA”. However, in the notation of omission data that have not been standardized, there is a case in which it is difficult to clearly determine normal data and abnormal data after the data are recorded. Accordingly, in representative libraries that process data, omission data are indicated as “NaN” or “NA” for reason of simplicity and function.

In an embodiment of the present disclosure, abnormal data are substituted with omission data by indicating the abnormal data as “NaN” or “NA”.

If a method of deleting data en bloc in order to process omission data 1310 is used, a perfect data set that prevents contamination against the omission data may be obtained, but the method may not be sufficiently used for data because the degree that data are deleted is great depending on a location of the omission data. For example, if a row including the omission data 1310 is deleted from the time-series data 1300 en bloc, a row T1 and a row T10 remain. In this case, it may be insufficient to obtain useful information by using the time-series data 1300.

Alternatively, if a method of interpolating time-series data en bloc in order to process the omission data 1310 is used, data can be preserved as much as possible by arbitrarily recovering omission data based on close data or the past data of the omission data. However, the results of the analysis and learning of the restored data may be contaminated because the quality of the data is not good if impractical interpolation is performed because the restored data are not accurate data.

For example, if a row including the omission data 1310 is interpolated en bloc in the time-series data 1300, the quality of data that are generated through interpolation is inevitably degraded because data in a column N3 are interpolated by using only obtained data in the row T1 and the row T10. Furthermore, the accuracy of interpolation cannot be guaranteed because omission data irregularly occur even in the case of data in a column N7, a column N8, and a column N10.

Accordingly, a method of determining whether it is possible to recover data in each of a column N3, the column N7, the column N8, and a column N10 and whether the quality of the data is increased by recovering the data is required.

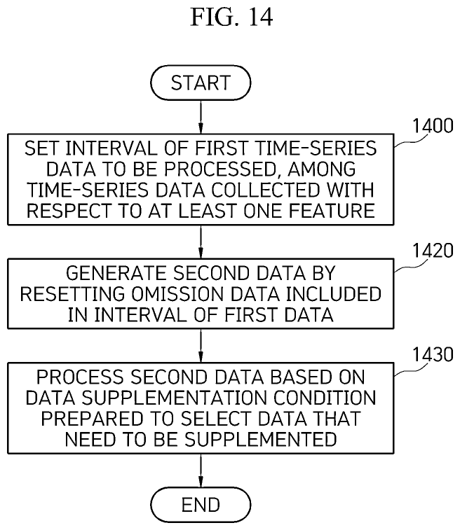

FIG. 14 is a diagram for describing a processing process if omission data are included in an embodiment of the present disclosure.

The processor 250 according to in an embodiment of the present disclosure sets the interval of first time-series data to be processed, among time-series data collected with respect to at least one piece of feature information (1410).

The feature information means the contents of the collected data as described in relation to FIG. 13. The collected data have been collected in time series with respect to the at least one piece of feature information.

The processor 250 may receive the collected data from an external device, such as a server, but the collected data may be data collected by the electronic device 200, and the present disclosure is not limited to any one of them.

The processor 250 may set the interval of first data on the basis on a required time interval. In this case, the first data are data to be processed among the collected data.

If analysis is performed on the collected data, for example, when the classification of a data pattern to which clustering has been applied is applied, performance may be increased by excluding data including many omission data in the analysis. However, in the case of data including few omission data to some extent, performance may be increased by using the data as much as possible after recovering the data through interpolation. That is, there is need for a criterion on which data including omission data will be permitted to what degree and selected. Accordingly, if the first data are properly set, this may contribute to increasing the processing quality of the collected data, and correct results may be derived.

As an embodiment, the processor 250 may set a first interval of the first data based on a degree of omission data included in each interval, among a plurality of intervals of the first data. For example, if a time interval is set by using the collected data, an interval which may be set as the first data may be plural. If a degree of omission data included in a specific interval, among the plurality of intervals, is small, the specific interval may be evaluated as having better quality of data than other intervals. Accordingly, the processor 250 may set, as the first interval of the first data, an interval having the smallest degree of omission data that are included in the plurality of intervals of the first data.

Furthermore, the processor 250 may set the first interval of the first data based on a degree that omission data included in the first interval are consecutive or a degree that omission data included in the first interval are summed. For example, in the case of an interval in which omission data include 3 consecutive data and an interval in which 3 omission data are present, but include data that are distributed and can be supplemented through interpolation, there is a good possibility that the latter interval is an interval including more valid data and may be set as the first interval.

As still another embodiment, the processor 250 may identify a degree of all omission data within collected data, and may set an interval having a small degree of omission data included in a corresponding interval compared to a degree of all omission data as the first interval of the first data.

The processor 250 according to in an embodiment of the present disclosure generates second data by resetting the omission data included in an interval of the first data (1420).

The interval of the first data may include uncollected data in addition to omission data. The uncollected data means a case in which collected data are not present because a data collection start time or a collection end time is different when data that have been omitted while data are collected are excluded and different data are listed in time series.

According to an embodiment of the present disclosure, resetting the omission data means that uncollected data included in the interval of first data are set as omission data. This is for performing the same processing on the existing omission data and the uncollected data upon data processing by identically changing the forms of the existing omission data and the uncollected data.

The processor 250 according to in an embodiment of the present disclosure processes the second data based on a data supplementation condition that is prepared to select data that need to be supplemented (1430).

According to an embodiment of the present disclosure, the processor 250 may set the data supplementation condition based on at least one of the ratio, period, and degree of omission data included in the second data. In this case, the data supplementation condition may be applied to one data set of collected data based on at least one feature. For example, the data supplementation condition may be applied to a data set that has been collected in accordance with each feature, among data that have been collected with respect to a plurality of features. Alternatively, the data supplementation condition may be applied to a data set that has been collected in accordance with each condition, among data that have been collected in 2 or more different conditions with respect to one feature.

In this case, the processor 250 may set the data supplementation condition by receiving a user input for the data supplementation condition through the input unit 210, or may receive data for the data supplementation condition from an external device through the communication unit 220. Furthermore, the processor 250 may perform at least some of data analysis and processing and the generation of result information for setting an optimized data supplementation condition on which the collected data or the second data are processed by using at least one of machine learning, a neural network, or a deep learning algorithm as a rule-based algorithm or an artificial intelligence algorithm.

In this case, processing the second data includes performing various types of data processing, such as selecting third data that satisfy the data supplementation condition from the second data or deleting or interpolating the second data or the selected third data.

More specifically, the data supplementation condition is described. The processor 250 may process the second data when the ratio of omission data included in the second data is greater than a predefined value.

When the period of omission data included in the second data is greater than a predefined value, the processor 250 may process the second data. In this case, the period of the omission data may mean the period of consecutive omission data or the sum of periods corresponding to omission data that are distributed to the second data.

When a degree of omission data included in the second data is greater than a predefined value, the processor 250 may process the second data.

According to an embodiment of the present disclosure, more rational and high-quality data processing can be performed because data to be supplemented are selected and a task therefor is performed based on a situation of omission data included in data without deleting or interpolating the data en bloc.

According to an embodiment of the present disclosure, a user can use only data having high quality by efficiently selecting time-series data based on desired quality although the time-series data includes omission data.

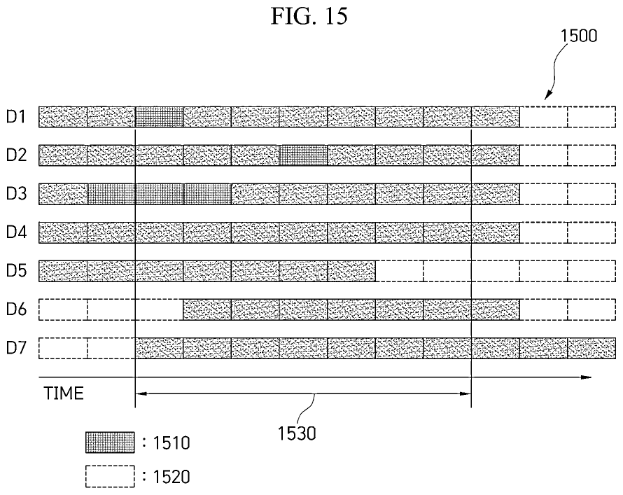

FIGS. 15 to 18 sequentially illustrate one embodiment in which collected data are processed according to the flow of the operation described with reference to FIG. 14. In the present embodiment, data D1 to D7 collected with respect to one feature are processed, but the present disclosure is not limited to the embodiment. Data that have been collected with respect to a plurality of features may be processed. In this case, the data illustrated in FIGS. 15 to 18 may be present for each feature or the data D1 to D7 may have different features.

FIG. 15 is a diagram illustrating a form in which the interval of first data is set according to an execution method according to an embodiment of the present disclosure. FIG. 15 is described in relation to step 1410 in FIG. 14.

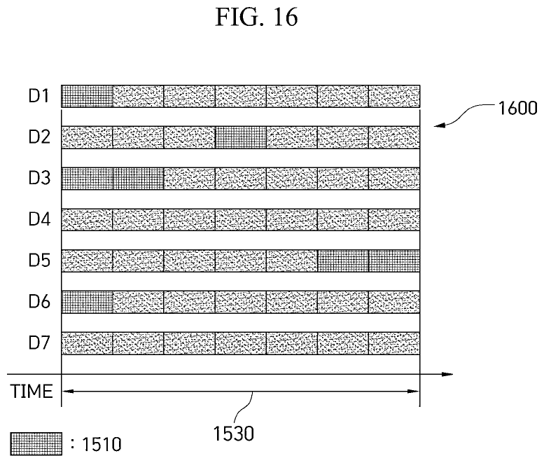

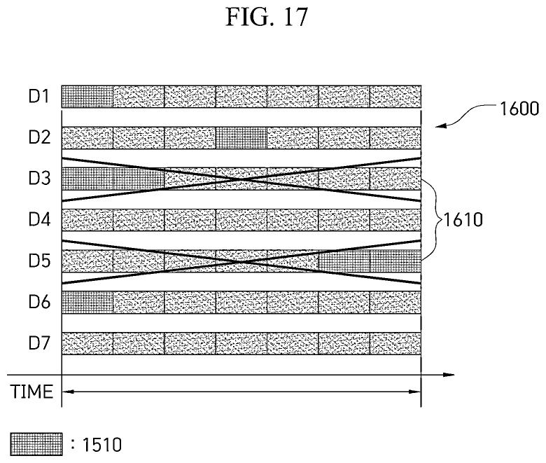

FIG. 16 illustrates time-series data 1500 including omission data 1510 and uncollected data 1520. The processor 250 may set an interval 1530 of first data to be processed in the collected time-series data 1500. According to an embodiment of the present disclosure, the processor 250 may set a first interval 1530 of the first data, among a plurality of intervals of the first data, by considering all of the omission data 1510 and the uncollected data 1520.

For example, in the case of the interval 1530 that has now been set, the number of omission data and uncollected data is 7. In contrast, if the interval 1530 is advanced by one column and set, the number of omission data and uncollected data is 9. Furthermore, as illustrated in a row D3, it may be seen that the quality of data is further degraded because the number of consecutive omission data number is increased to 3.

An embodiment of the present disclosure can contribute to further increasing the quality of data as part of a pre-processing process of selecting data that satisfy the data supplementation condition by setting the interval of the first data, among the collected data.

FIG. 16 is a diagram illustrating a form in which second data are generated according to an execution method according to an embodiment of the present disclosure. FIG. 16 is described in relation to step 1420 in FIG. 14.

FIG. 16 illustrates second data 1600 that have been generated by processing the first data set in FIG. 15. According to an embodiment of the present disclosure, the processor 250 generates the second data 1600 by resetting the omission data 1510 included in the interval 1530 of the first data.

In this case, resetting the omission data means that the uncollected data 1520 included in the interval 1530 of the first data are set as the omission data 1510. This is for performing the same processing on the existing omission data 1510 and the uncollected data 1520 upon data processing by identically changing the forms of the existing omission data 1510 and the uncollected data 1520.

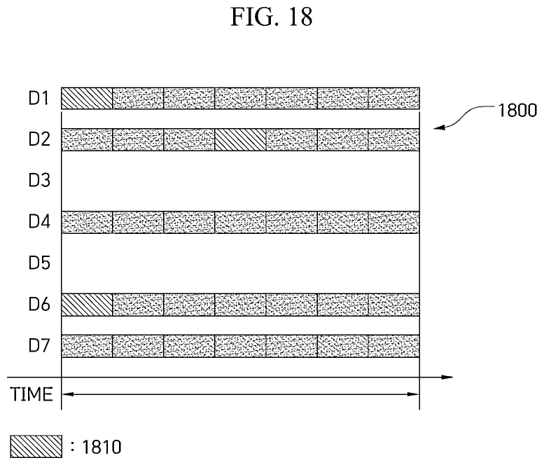

FIG. 17 is a diagram illustrating a form in which second data are processed based on a data supplementation condition according to an execution method according to an embodiment of the present disclosure. FIG. 18 is a diagram illustrating a form in which second data are processed according to an execution method according to an embodiment of the present disclosure. FIGS. 17 and 18 are described in relation to step 1430 in FIG. 14.

According to an embodiment of the present disclosure, the processor 250 may set the data supplementation condition based on at least one of the ratio, period, and degree of the omission data 1510 included in second data 1600.

More specifically, the data supplementation condition is described. The processor 250 may process the second data 1600 when the ratio of omission data 1510 included in the second data 1600 is greater than a predefined value.

When the period of the omission data 1510 included in the second data 1600 is greater than a predefined value, the processor 250 may process the second data 1600. In this case, the period of the omission data 1510 may be the period of the consecutive omission data 1510 or may mean the sum of periods corresponding to the omission data 1510 that have been distributed to the second data 1600.

When a degree of the omission data 1510 included in the second data 1600 is greater than a predefined value, the processor 250 may process the second data 1600.

In this case, processing the second data 1600 by the processor 250 includes selecting third data 1610 that satisfy the data supplementation condition from the second data 1600.

For example, the data supplementation condition that has been set with respect to the second data 1600 illustrated in FIG. 17 includes that the number of omission data 1610 is 2 or more. The processor 250 may select data that satisfy the data supplementation condition as the third data 1610 that need to be supplemented.

In this case, the data supplementation condition may be applied to one data set, among the collected data, based on at least one feature. For example, it is assumed that the second data 1600 are data obtained by measuring the amount of fine dust for each city and a row D1 to a row D7 are data for the amounts of fine dust collected in different cities. A data supplementation condition on which a city in which the number of omission data 1610 is 2 or more is identified may be applied to each of the row D1 to the row D7. The processor 250 may select data of the row D3 and the row D5, among the second data 1600, as the third data 1610 that needs to be supplemented.

The processor 250 according to in an embodiment of the present disclosure may delete or interpolate the selected third data 1610. In the present embodiment, the selected third data 1610 has been deleted.

The processor 250 identifies omission data, among data that remain after the third data are selected and corresponding processing is performed, as data 1810 that need to be interpolated. The processor may perform interpolation on the data 1810 that need to be interpolated, and may perform analysis by using restored data 1800.

According to an embodiment of the present disclosure, data having high quality can be provided because data that need to be supplemented are selected based on the data supplementation condition. Furthermore, higher-quality data analysis can be performed because selected data are analyzed based on data obtained by processing the selected data and thus an impractical deletion task or an interpolation task can be avoided.

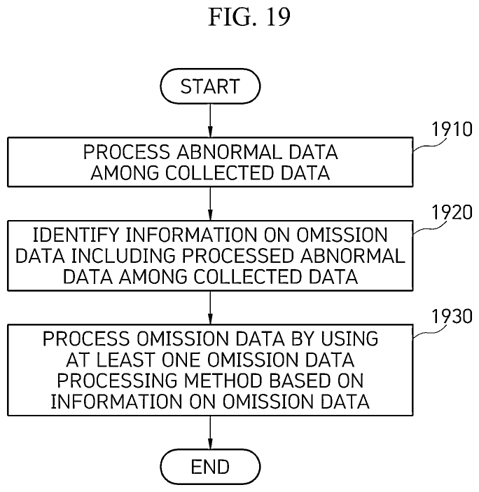

FIG. 19 is a diagram for describing a process of processing abnormal data and omission data according to another embodiment of the present disclosure.

The processor 250 according to in an embodiment of the present disclosure processes abnormal data, among collected data (1910). In step 1910, an operation of the processor 250 may be an operation of processing abnormal data, among the first data, in relation to step 1420 in FIG. 14.

The collected data may be collected in time series with respect to at least one piece of feature information. For example, the collected data may be temperature data collected by a temperature sensor. The processor 250 may receive the collected data from an external device, such as a server, but may be data collected by the electronic device 200, and the present disclosure is not limited to any of them.

According to an embodiment of the present disclosure, the processor 250 may process the abnormal data of the collected data by substituting the abnormal data with omission data or may interpolate the abnormal data into proper data by using data collected before and after the abnormal data.

As an embodiment, the processor 250 identifies information on omission data including the processed abnormal data, among the collected data (1920). In step 1920, an operation of the processor 250 may be an operation of identifying information on the omission data including the processed abnormal data, among the first data, and processing the omission data included in the second data by using at least one omission data processing method based on the identified information on the omission data, in relation to step 1430 in FIG. 14.

According to an embodiment of the present disclosure, the collected data may include the omission data in addition to the abnormal data. According to an embodiment of the present disclosure, the omission data include the omission data that substitute the abnormal data in step 1910 and the omission data previously included in the collection data.

According to an embodiment of the present disclosure, the information on the omission data includes at least one of information relating to a location of the omission data and information relating to the continuity of the omission data. According to an embodiment of the present disclosure, the information relating to the location of the omission data includes information relating to a row and column at which the omission data have been disposed in data having a table form, for example. Furthermore, the information relating to the continuity of the omission data includes information relating to a degree (or time) that the omission data are consecutive and information based on which the tendency or pattern of the omission data, such as a distribution aspect of the omission data, can be identified.

Accordingly, the processor 250 may identify information on the omission data, including at least one of the information relating to the location of the omission data and the information relating to the continuity of the omission data.

The processor 250 according to an embodiment of the present disclosure processes the omission data by using at least one omission data processing method based on the information on the omission data (1930).

The processor 250 according to an embodiment of the present disclosure may perform the supplement of the omission data based on the information relating to the location of the omission data and/or the information relating to the continuity of the omission data.

In this case, the processor 250 may identify the at least one omission data processing method that will process the omission data corresponding to at least one interval, based on the information on the omission data. The processor 250 may supplement the omission data by also considering parameter information that adjusts a degree of the processing of the omission data, based on the information on the omission data. The parameter information according to the present embodiment may include information relating to the interval including the omission data, information relating to the omission data processing method, or an omission data processing condition.

For example, the processor 250 may process 10 consecutive omission data by applying one omission data processing method to an interval including 10 consecutive omission data. As another example, the processor 250 may process the 10 consecutive omission data by segmenting the interval including the 10 consecutive omission data into three intervals and applying different omission data processing methods to the three intervals. Additionally, the processor 250 may derive the final supplementation data value by applying the mean value or a predetermined ratio of data values that have been supplemented according to each processing method by applying a plurality of omission data processing methods with respect to each interval.

In this case, the processor 250 may process the omission data based on a condition that determines whether the omission data will be processed, that is, a condition that determines whether data will be supplemented. For example, the processor 250 may process the omission data based on a condition in which the supplementation is performed only when omission data of all data are equal to or less than 20% or the supplementation is performed on only 10 or less consecutive omission data that include omission data less than 30%, among all data.

According to an embodiment of the present disclosure, the processor 250 may perform at least some of data analysis and processing for adjusting the degree of the processing of the omission data based on the information on the omission data and the generation of result information thereof by using at least one of machine learning, a neural network, or a deep learning algorithm as a rule-based or artificial intelligence algorithm.

Furthermore, in order to adaptively perform the supplement of the omission data in response to a request from a user, the processor 250 may receive a user input relating to at least one omission data processing method that will process the omission data corresponding to at least one interval through the input unit 210. Accordingly, the processor 250 may supplement the omission data by applying the at least one omission data processing method based on parameter information defined by the user.

In this case, the omission data processing method may include “mean”, “median”, “frequent”, “ffill”, “bfill”, “linear_interpolation”, “spline_interpolation”, “stineman_interpolation”, “KNN”, “ARIMA”, “Randomforest”, “NAOMI”, and “BRITS”, for example, but the present disclosure is not limited thereto.

According to an embodiment of the present disclosure, more rational and high-quality data processing can be performed because omission data can be supplemented by applying a method that is optimized based on the state of an interval including the omission data.

According to an embodiment of the present disclosure, higher-quality data supplementation can be performed because an interpolation and substitution method can be differently applied depending on the utilization of data.

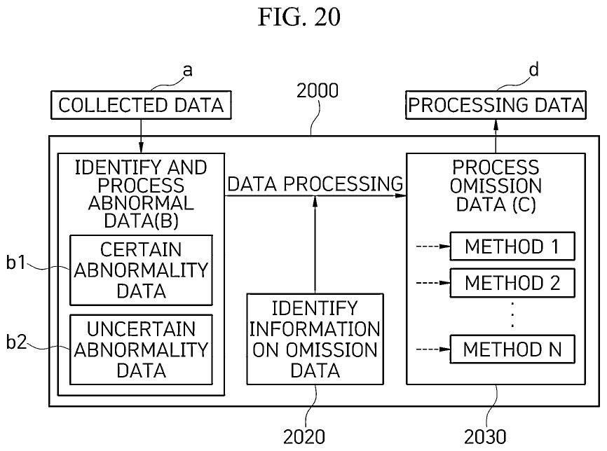

FIG. 20 is a diagram illustrating a form in which the electronic device operates according to an embodiment of the present disclosure. In the present embodiment, data processing 2000 for omission data is described. Contents redundant with the contents described with reference to FIG. 20 are applied identically with those described with reference to FIG. 19, and thus a detailed description is omitted.

The processor 250 according to an embodiment of the present disclosure processes abnormal data (b), among collected data (hereinafter referred to as “collection data (a)”) (2010).

More specifically, the abnormal data (b) include certain abnormality data (b1) and uncertain abnormality data (b2). The certain abnormality data (b1) means error data that are clearly determined because the error data have a value greater than a minimum-maximum range to which a value of the collection data (a) may belong. The uncertain abnormality data (b2) mean abnormal data that are uncertain whether they are abnormal data because the abnormal data are not a clear error, but are quite different from data obtained before and after corresponding data when the abnormal data are compared with the obtained data.

The processor 250 identifies the abnormal data (b) including the certain abnormality data (b1) and the uncertain abnormality data (b2), among the collection data (a), and processes the certain abnormality data (b1) and the uncertain abnormality data (b2). For example, the processor 250 may process the certain abnormality data (b1) of the collection data (a) by substituting the certain abnormality data (b1) with omission data, may process the uncertain abnormality data (b2) of the collection data (a) by substituting the uncertain abnormality data (b2) with omission data, or may interpolate the abnormal data (b) into proper data by using data that are collected before and after the uncertain abnormality data (b2). In this case, the processor 250 may receive a user input that determines a value of the uncertain abnormality data (b2) through the input unit 210.

The processor 250 according to an embodiment of the present disclosure identifies information on omission data (c) including processed abnormal data, among the collection data (a) (2020).

The processor 250 according to an embodiment of the present disclosure processes the omission data (c) by using at least one omission data processing method based on information on the omission data (c) (2030). As a result, the processor 250 obtains processing data (d) from the collection data (a).

According to an embodiment of the present disclosure, abnormal data can be processed more precisely because the abnormal data are processed by being divided into certain abnormality data and uncertain abnormality data.

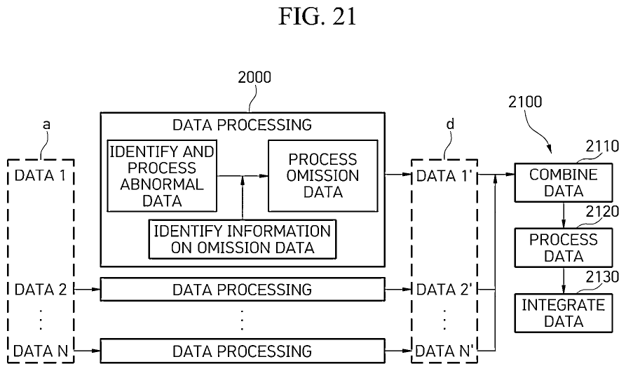

FIG. 21 is a diagram illustrating a form in which the electronic device operates according to another embodiment of the present disclosure. In the operating form of FIG. 21, a method 2100 of integrating a plurality of processing data (d) that are obtained by processing a plurality of collection data (a) is described.

According to an embodiment of the present disclosure, in order to integrate the plurality of collection data (a) including DATA 1, DATA 2, . . . , DATA N, the data processing 1400 that has been described with reference to FIGS. 20 and 21 needs to be first performed on each of the collection data (a). The processing data (d) obtained through the data processing 2000 with respect to each of the collection data (a) include DATA 1′, DATA 2′, DATA N′.

The processor 250 according to an embodiment of the present disclosure combines the obtained processing data (d) (2110).

A process of combining the processing data (d) is described in detail with reference to data in Table 2. It is assumed that data 1, data 2, and data 3 illustrated in Table 2 are the processing data (d) on which the data processing 2000 has been individually completed.

TABLE 2

| | | |
|---|---|---|
| Data 1 | January 1^{st} 0:00 o'clock to | Measured in a 1-minute unit |
| | January 10^{th} 24:00 | |
| Data 2 | January 1^{st} 3 o'clock to | Measured in a 1-hour unit |
| | January 10^{th} 23:00 | |
| Data 3 | January 1^{st} midnight to | Measured in a 3-hour unit |
| | January 11^{th} 24:00 | |

According to an embodiment of the present disclosure, the processor 250 may set a combination interval of the plurality of processing data (d) as illustrated in Table 3.

TABLE 3

| | |
|---|---|
| Combination interval 1 | January 1^{st} 3 o'clock to January 10^{th} 23:00 |
| Combination interval 2 | January 1^{st} 0:00 o'clock to January 10^{th} 24:00 |

According to an embodiment of the present disclosure, the processor 250 may reset omission data based on a combination interval. According to an embodiment of the present disclosure, resetting the omission data means that uncollected data are set as omission data when the uncollected data occur by being extended more than a time interval during which collection data are collected. This is for subjecting the existing omission data and the uncollected data to the same processing upon data processing by identically changing the forms of the existing omission data and the uncollected data.

For example, if a combination interval is set as a combination interval 1, it is not necessary to reset additional omission data because some data of data 1, all the data of data 2, and some data of data 3 are used.

However, if the combination interval is set as a combination interval 2, it is not necessary to set omission data because all the data of data 1 and some data of data 3 are used. In contrast, it is necessary to reset omission data with respect to uncollected data corresponding to a corresponding time because data 2 do not include data after January 1^{st} 0 o'clock to before January 1^{st} 3 o'clock and after January 10^{th} 23:00 to before January 10^{th} 24:00.

According to an embodiment of the present disclosure, the processor 250 may combine data based on a data collection period of the plurality of processing data (d). For example, the processor 250 may perform (reindex) the indexing of data again based on the data collection period of the plurality of processing data (d). More specifically, the processor 250 may combine the plurality of processing data (d) by up-sampling or down-sampling each of the plurality of processing data (d) based on the data collection period of the plurality of processing data (d).

For example, if the combination period is set to a 1-minute unit, data 2 and data 3 need to be up-sampled. If the combination period is set to a 1-hour unit, data 1 need to be down-sampled, and data 3 need to be up-sampled.

In this case, a widely known statistical calculation method, such as the mean, may be used as down-sampling. However, up-sampling may be performed by applying at least one of the omission data processing methods described with reference to FIG. 15 because a processing method for up-sampling is very various and thus corresponding data recovery effects are very different. However, this is merely an example, and methods of performing up-sampling and down-sampling may be applied without limit.

After the data are combined, the processor 250 may perform data processing 2120 on the combined data again. In this case, the data processing 2120 may be the same as the data processing 2000. The data processing 2120 and the data processing 2000 may be performed by the same processor or different processors. More specifically, the processor 250 may obtain a plurality of processing data by processing each of a plurality of collection data, may combine the plurality of processing data, may process abnormal data among the combined data, may identify information on omission data including the processed abnormal data among the combined data, and may process the omission data by using at least one omission data processing method based on the information on the omission data. The processor 250 may integrate the data by processing the omission data (2130).

According to an embodiment of the present disclosure, high-quality data supplementation can be performed although data are combined because the embodiment of the present disclosure can be applied to data in which a plurality of single data has been combined.

According to an embodiment of the present disclosure, faulty data are processed by performing quality verification based on time-series data having a periodical feature. Accordingly, overall performance results can be improved because the embodiment of the present disclosure can be used in learning and analysis based on data having high data quality.

Furthermore, more rational and high-quality data processing can be performed because data to be supplemented are selected and a task therefor is performed based on a situation of omission data included in data. Furthermore, higher-quality data analysis can be performed because high-quality data are provided based on a data supplementation condition and an impractical deletion task or an interpolation task can be avoided.

In addition, more rational and high-quality data processing can be performed because omission data are supplemented by applying a method optimized based on the state of an interval including the omission data. Furthermore, higher-quality data supplementation can be performed because different interpolation and substitution methods can be applied depending on the utilization of data. Furthermore, high-quality data supplementation can be performed although data are combined because an embodiment of the present disclosure can be applied to data in which a plurality of single data has been combined.

The method of the electronic device generating a predictive model based on the classification of patterns of time-series data to which a pre-processing pipeline has been applied according to an embodiment of the present disclosure may be implemented in the form of a program (or application) in order to be executed by being combined with a server, that is, hardware, and may be stored in a medium.

The aforementioned program may include a code coded in a computer language, such as C, C++, JAVA, or a machine language which is readable by a processor (CPU) of a computer through a device interface of the computer in order for the computer to read the program and execute the methods implemented as the program. Such a code may include a functional code related to a function, etc. that defines functions necessary to execute the methods, and may include an execution procedure-related control code necessary for the processor of the computer to execute the functions according to a given procedure. Furthermore, such a code may further include a memory reference-related code indicating at which location (address number) of the memory inside or outside the computer additional information or media necessary for the processor of the computer to execute the functions needs to be referred. Furthermore, if the processor of the computer requires communication with any other remote computer or server in order to execute the functions, the code may further include a communication-related code indicating how the processor communicates with the any other remote computer or server by using a communication module of the computer and which information or media needs to be transmitted and received upon communication.

The medium in which the method is stored means a medium that semi-permanently stores data and that is readable by a device, not a medium that stores data for a short moment like a register, a cache, or memory. Specifically, examples of the medium in which the method is stored include ROM, RAM, CD-ROM, a magnetic tape, a floppy disk, optical data storage, etc., but the present disclosure is not limited thereto. That is, the program may be stored in various recording media in various servers which may be accessed by a computer or various recording media in a computer of a user. Furthermore, the medium may be distributed to computer systems connected over a network, and a code readable by a computer in a distributed way may be stored in the medium.

The steps of the method or algorithm described in relation to the embodiments of the present disclosure may be directly implemented as hardware, may be implemented as a software module executed by hardware, or may be implemented by a combination of them. The software module may reside in random access memory (RAM), read only memory (ROM), erasable programmable ROM (EPROM), electrically erasable programmable ROM (EEPROM), flash memory, a hard disk, a detachable disk, CD-ROM, or a computer-readable medium having a given form, which is well known in the field to which the present disclosure pertains.

Although the embodiments of the present disclosure have been described with reference to the accompanying drawings, a person of ordinary knowledge in the art to which the present disclosure pertains may understand that the present disclosure may be implemented in other detailed forms without changing the technical spirit or essential characteristics of the present disclosure. Accordingly, it is to be understood that the aforementioned embodiments are only illustrative, but are not limitative in all aspects.

What is claimed is:

1. A method of generating a predictive model based on a classification of patterns of time-series data to which a pre-processing pipeline has been applied, the method being performed by an electronic device and comprising:
receiving single time-series data or multiple types of time-series data that are collected in a specific domain;
drawing time-series data corresponding to an identical domain and an identical time interval, among the received single time-series data or multiple types of time-series data;
pre-processing the drawn time-series data by applying a pre-processing pipeline built by applying at least one pre-processing module to the drawn time-series data;
generating a pattern classification model for classifying patterns of the pre-processed time-series data based on a clustering of the pre-processed time-series data;
generating a predictive model for predicting feature information of the drawn time-series data based on a cluster that is generated as results of the clustering of the pre-processed time-series data; and
storing the pattern classification model and the predictive model.

2. The method of claim 1, wherein the drawing of the time-series data corresponding to the identical domain and the identical time interval, among the received single time-series data or multiple types of time-series data comprises drawing the time-series data that correspond to an identical domain and that are included in the identical time interval, among time-series data at a plurality of different places, which have been previously collected in the specific domain.

3. The method of claim 2, wherein the drawing of the time-series data corresponding to the identical domain and the identical time interval, among the received single time-series data or multiple types of time-series data comprises drawing the time-series data by combining conditions for a plurality of time intervals, among time intervals corresponding to time-series data that have been previously collected in the specific domain.

4. The method of claim 1, wherein the pre-processing of the time-series data comprises performing at least one of:
pre-processing for purifying the drawn time-series data based on a pre-determined reference period,
pre-processing for processing time-series data or each time-series data included in a time interval having an abnormal value, among the drawn time-series data, as a loss value, or
pre-processing for performing exclusion processing on time-series data included in a time interval in which time-series data having a preset first threshold or more have been lost and performing recovery processing on time-series data included in a time interval in which time-series data less than a second threshold smaller than the first threshold have been lost by supplementing the time-series data.

5. The method of claim 1, wherein the pre-processing of the time-series data comprises:
segmenting an entire time interval of the time-series data into a plurality of time intervals;
building the pre-processing pipeline by applying at least one of an identical type of pre-processing module and different types of pre-processing modules to a time interval to be pre-processed, among the segmented time intervals; and
pre-processing the time-series data by operating the pre-processing pipeline.

6. The method of claim 5, wherein the building of the pre-processing pipeline by applying the at least one of the identical type of pre-processing module and the different types of pre-processing modules to the time interval to be pre-processed, among the segmented time intervals, comprises, in response to the time-series data being the multiple types of time-series data,
applying a first pre-processing module to a first pre-processing target time interval of first and second single time-series data that constitute the multiple types of time-series data; and
applying a second pre-processing module to a second pre-processing target time interval subsequent to the first pre-processing target time interval of the first and second single time-series data.

7. The method of claim 5, wherein the building of the pre-processing pipeline by applying the at least one of the identical type of pre-processing module and the different types of pre-processing modules to the time interval to be pre-processed, among the segmented time intervals, comprises, in response to the time-series data being the multiple types of time-series data,
applying a pre-processing module corresponding to each pre-processing target time interval of first single time-series data that constitute the multiple types of time-series data; and
applying a pre-processing module corresponding to each pre-processing target time interval of second single time-series data that constitute the multiple types of time-series data, after completing the application of the pre-processing module to the first single time-series data.

8. The method of claim 1, wherein the pre-processing of the time-series data comprises selecting a pre-processing pipeline having a smallest difference between each of data that have been pre-processed by a plurality of built pre-processing pipelines, respectively, and correct answer data that have been previously prepared when the plurality of built pre-processing pipelines is present.

9. The method of claim 1, wherein the pre-processing of the time-series data comprises building the pre-processing pipeline based on input and output feature information of the pre-processing module and input and output feature information between a previous pre-processing module and a subsequent pre-processing module.

10. The method of claim 9, wherein the pre-processing of the time-series data comprises:
selectively outputting pre-processing modules which are applicable depending on whether the time-series data that are input correspond to a single type or multiple types;
selectively applying a first pre-processing module, among the output pre-processing modules;
selectively outputting pre-processing modules that are applicable after the first pre-processing module depending on whether the time-series data output by the first pre-processing module correspond to a single type or multiple types; and
selectively applying a second pre-processing module, among the output pre-processing modules.

11. The method of claim 1, wherein the pre-processing of the time-series data comprises:
selecting at least one of the previously built pre-processing pipelines when receiving new single or multiple types of time-series data; and
applying the selected pre-processing pipeline to any one interval of the segmented intervals of the time-series data.

12. The method of claim 1, wherein the pre-processing of the time-series data comprises pre-processing the time-series data by segmenting and applying the built pre-processing pipeline based on a physical characteristic interval.

13. The method of claim 1, wherein the generating of the pattern classification model for classifying the patterns of the pre-processed time-series data based on the clustering of the pre-processed time-series data comprises generating the pattern classification model that classifies the patterns of the time-series data by a pre-designated clustering number or an automatically adjusted clustering number.

14. The method of claim 1, wherein the generating of the pattern classification model for classifying the patterns of the pre-processed time-series data based on the clustering of the pre-processed time-series data comprises generating the pattern classification model for classifying the patterns of the time-series data based on the drawn time-series data and a label corresponding to the drawn time-series data.

15. The method of claim 1, wherein the generating of the predictive model for predicting the feature information of the drawn time-series data comprises generating predictive models having a number corresponding to all clusters generated as the results of the clustering.

16. The method of claim 1, wherein the generating of the predictive model for predicting the feature information of the drawn time-series data comprises:
generating predictive models having a number corresponding to upper n (n is a natural number) selected clusters each having a large number of time-series data included in each of all clusters generated as the results of the clustering; and
generating the pattern classification model again based on the selected clusters so that the selected clusters correspond to the number of generated predictive models.

17. The method of claim 1, further comprising:
receiving time-series data that are collected at a new place and that have a domain identical with the specific domain;
classifying the received time-series data as a corresponding cluster by inputting the received time-series data to the pattern classification model;
selecting a predictive model corresponding to the classified cluster; and
outputting results of prediction of feature information of the received time-series data based on the selected predictive model.

18. An electronic device comprising:
a processor configured to receive single or multiple types of time-series data that are collected in a specific domain, build a pre-processing pipeline by applying at least one pre-processing module to the time-series data, and pre-process the time-series data by applying the built pre-processing pipeline.

19. An electronic device comprising:
a processor configured to draw time-series data corresponding to an identical domain and an identical time interval, among time-series data that have been previously collected in a specific domain, generate a pattern classification model for classifying patterns of the time-series data based on a clustering of the drawn time-series data, store the generated pattern classification model, generate a predictive model for predicting feature information of the drawn time-series data based on a cluster that is generated as results of the clustering of the time-series data, and store the generated predictive model.
